(19) United States
(12) Patent Application Publication
(10) Pub. No.: US 2024/0291535 A1
(43) Pub. Date: Aug. 29, 2024

(54) METHOD OF OBTAINING CHANNEL STATE INFORMATION IN WIRELESS COMMUNICATION NETWORK HAVING ARTIFICIAL WAVE TRANSFORMER

(71) Applicant: University of Manitoba, Winnipeg (CA)

(72) Inventors: Firas Fredj, Winnipeg (CA); Amal Feriani, Saint-Laurent (CA); Amine Mezghani, Winnipeg (CA); Ekram Hossain, Winnipeg (CA)

(21) Appl. No.: 18/432,222

(22) Filed: Feb. 5, 2024

Related U.S. Application Data
(60) Provisional application No. 63/446,646, filed on Feb. 17, 2023.

(51) Int. Cl. H04B 7/06; H04W 24/02

(52) U.S. Cl. CPC H04B 7/0626; H04W 24/02

(57) ABSTRACT

A method of obtaining channel state information of a communication channel between a user device and an access point with plural antennas features steps of forming separate statistical models representative of a first channel portion between the access point and a wave transformer located at a geographically intermediate location between the access point and the user device, which is configured to reflect electromagnetic signals between the access point and the user device and has electronically reconfigurable antennas, and a second channel portion between the wave transformer and the user device; and processing, using respective machine learning algorithms configured to determine parameters of a type of tractable statistical distribution selected to represent both the first and second portions of the channel, a transmitted signal so as to form parametrized tractable statistical distributions respectively defining the separate statistical models of the first and second portions of the communication channel.

This application claims the benefit under 35 U.S.C. 119(e) of U.S. Provisional Application Ser. No. 63/446,646 filed Feb. 17, 2023.

### FIELD OF THE INVENTION

The present invention relates to a method of obtaining channel state information in a wireless communication network which includes an artificial wave transformer having electronically reconfigurable antennas, and more particularly to such a method in which machine learning is used to approximate a statistical model of the communication channel, based on which the channel state information is determined.

### BACKGROUND

Millimeter-wave (mmWave) communication is one of the emerging technologies for 5G/6G communication systems and beyond to meet the high data rate and spectral efficiency requirements [2]. Although mmWave communications offer a significant gain in throughput thanks to the increased available bandwidth, they are more susceptible to blockages due to rapid signal attenuation and severe path loss. In this context, reconfigurable intelligent surfaces (RISs) have been proposed to mitigate the challenges in mmWave communication systems and also enable smart and reconfigurable wireless environments [3], [4]. An RIS is a two-dimensional (2D) array consisting of a large number of passive low-cost reflecting elements that redirect the impinging electromagnetic waves following a specific phase shift pattern to create a favorable environment for the propagation of the signals [5], [6]. By manipulating the signals' phases and amplitudes, the RIS can create constructive or destructive interference, amplify or attenuate the signals, and improve the communication link quality and coverage [7]. This technology has many potential benefits, including improving the signal-to-noise ratio (SNR), increasing coverage and capacity, reducing power consumption, and enhancing security and privacy [8]-[10]. In contrast to the non-regenerative relays (also called repeaters), the RIS operates efficiently in full-duplex without self-interference or noise amplification [11], [12]. As a passive structure, the RIS introduces no additional noise beyond the environmental thermal noise level, similar to other passive scattering objects in the system. This stands as a notable advantage over active repeaters [13].

To achieve the desired performance through passive and active beamforming, it is crucial to accurately estimate the channel state information (CSI) between the RIS and the transceivers [14], [15]. This is a challenging problem since (i) passive RISs are unable to transmit or receive training sequences, restricting the estimation to the pilot signals at the receiver, and (ii) the number of channel coefficients to estimate increases with the number of RIS elements, limiting the feasibility of CSI acquisition within a practical coherence time.

The existing literature may be categorized into two groups: cascaded channel estimation [16]-[22] and separate channel estimation [23]-[25].

Cascaded channel estimation focuses on estimating the channel between the user equipment (UE) and the base station (BS) through the RIS (UE-RIS-BS) from the training signal. For instance, a compressed sensing-based method, exploiting the sparse structure of the channels, was proposed for a single-user narrowband setup [16]. Additionally, a channel estimation scheme was developed for an RIS-aided multi-user broadband communication system by leveraging the shared channel between the RIS and BS (RIS-BS) among the users, which improves the training efficiency [17]. In mmWave communication, the channel has a low-rank structure and is modeled by using a small number of paths compared to the number of antennas at the transceivers where each path is distinguished by a direction of departure (DoD) and a direction of arrival (DoA). For the high dimensional RIS-BS and UE-RIS channels, a two-stage non-iterative downlink channel estimation framework can be adopted by first estimating the DoDs and DoAs for the RIS-BS and UE-RIS channels, respectively. Next, the cascaded channel UE-RIS-BS is directly estimated using the estimated DoDs and DoAs [18].

Several data-driven techniques have been proposed in RIS-aided systems and showed their effectiveness in the cascaded channel estimation problems [19]-[22]. For instance, a deep residual learning based approach was adopted to denoise the least square (LS) estimates by exploiting their spatial features with a conventional neural network (CNN) [19]. However, the LS estimator suffers from high training overhead due to the large number of channel coefficients to estimate. Addressing this shortcoming, previous work combines the super-resolution CNNs with deep denoising CNNs (DnCNNs) to estimate the cascaded channel and denoise the estimates in a MIMO OFDM communication system [20]. For semi-passive RIS where a small number of active elements are implemented in the RIS to receive the training sequence at the RIS from the transmitter, a hybrid method used compressed-sensing to estimate the cascaded channel coefficients from a low-resolution channel matrix and a DnCNN to further denoise and improve the estimation quality. Another line of work trained a neural network to compute the optimal locations of the active RIS elements, afterward the full channel matrix was extrapolated from the estimated channels of the selected active antennas using a CNN [22].

The knowledge of the cascaded channel enables the RIS configuration and optimal precoding. However, this approach has various drawbacks: (i) it is not suitable for user tracking due to the coupling of DoDs and DoAs at the RIS [26], [27], and (ii) it does not exploit the slow-varying feature of the RIS-BS channel to reduce the training overhead [3]. Acquiring separate channels, i.e., RIS-BS and UE-RIS channels, addresses these limitations as it decouples the cascaded channel and allows the identification of the channels' behavior in each part.

Separate channel estimation has granted attention in the existing literature. The decomposition of the cascaded UE-RIS-BS channel into two separate channels (i.e., UE-RIS and RIS-BS channels) has been studied in RIS-aided systems with fully-passive RIS elements. It was shown in [23] that the received signal follows the parallel factor tensor model which is used to develop an iterative alternating estimation scheme to obtain estimates of the UE-RIS and RIS-BS channels separately based on the Khatri-Rao factorization of the cascaded channel. However, the training overhead is still considerably high for a fully passive RIS. The use of semi-passive setup with active sensing elements at the RIS was proposed to estimate the RIS-BS channels as an initial step. Then, using the slow-varying property of the RIS-BS channel, only the UE-RIS channel is estimated in the training time of the subsequent coherence blocks [24]. In the same context of semi-passive RISs, a variational inference (VI)-based method was developed to reduce the training overhead and estimate the channels using only the uplink training signals [25].

The aforementioned works focused on estimating the I-CSI of either the cascaded channel or the separate channels. Estimating the I-CSIs is practical in scenarios involving static users, where the coherence time is sufficiently high. Although RIS phase-shifts optimization based on I-CSI achieves optimal performance in terms of achievable rate, it can be impractical in different scenarios such as high user mobility and large RISs. Indeed, I-CSI estimates and phase-shifts are updated in every coherence block, thereby leading to high training overhead and signaling complexity to control the RIS. Besides, the channel conditions in mmWave frequencies can change rapidly since the mmWave signals are more susceptible to blockages and attenuation [28]. Therefore, the coherence block of the channels is very limited for mobile users.

Statistical CSI (S-CSI) has recently emerged as an approach in addressing the active and passive beamforming in RIS-assisted wireless systems reducing the overhead of the channel estimation and extending the coverage for practical use [29], [30]. For example, The S-CSI was employed in a two-timescale beamforming design to reduce the training overhead and signal processing for acquiring the I-CSI with a specific transmission protocol [31]. The main idea relies on optimizing the phase-shifts based on the S-CSI while computing the downlink beamforming vectors based on the I-CSI of the effective channel between the UEs and the BS through the RIS (i.e., UE-RIS-BS channel including the phase-shifts optimized). A more sophisticated algorithm was proposed in [32] to cover a more general fading channel with discrete phase-shifts in both single-user and multi-user cases. In mmWave scenarios, the S-CSI was exploited for joint hybrid and passive precoder design using block-coordinate descent-based algorithms to maximize the ergodic capacity [33]. However, an approach of direct S-CSI estimation was not well studied in the literature for the RIS-aided systems. Typically, the S-CSI is characterized by the spatial channel covariance matrix (CCM) [34]. However, the estimation of the spatial CCM is challenging since its size increases as a function of the number of RIS elements. To address this problem, a CCM estimation method for the cascaded UE-RIS-BS channel was proposed in [35] by exploiting the low-rank and the semi-definite three-level Toeplitz structure of the covariance matrix. Table 1 summarizes several works in the area of I-CSI and S-CSI estimation in RIS-aided systems.

Considering the challenges discussed above about the estimation of the cascaded channel, it becomes desirable to solve the separate channel estimation problem in fully-passive RIS-aided network. As mentioned before, several works proposed methods to estimate the separate channels [24], [25]. However, these works suffer from high power consumption due to the semi-passive setup adopted.

### SUMMARY OF THE INVENTION

According to an aspect of the invention there is provided a method of obtaining, within a wireless communication network, channel state information of a communication channel between a user device and an access point having plural antennas and configured to wirelessly communicate with the user device; wherein the wireless communication network further includes a wave transformer located at a geographically intermediate location between the access point and the user device and configured to reflect electromagnetic signals between the access point and the user device, wherein the wave transformer has a plurality of electronically reconfigurable antennas; wherein the wireless communication network includes a central server having a processor and a non-transitory memory operatively connected to the processor and storing instructions to be executed thereon, wherein the central server is communicatively connected to the access point and configured to control the wireless communication network, wherein the central server is free of data connection with the wave transformer; the method comprising:

forming a statistical model of the communication channel, wherein the statistical model of the communication channel comprises separate statistical models representative of constituent portions of the communication channel, wherein the constituent portions of the communication include a first portion between the access point and the wave transformer and a second portion between the wave transformer and the user device;

wherein forming the statistical model of the communication channel comprises:

receiving, at one of the access point and the user device, a signal transmitted from another one of the access point and the user device;

using respective machine learning algorithms configured to determine parameters of a type of tractable statistical distribution selected to represent both the first and second portions of the communication channel, processing the signal to determine the parameters of a first tractable statistical distribution of the selected type and representative of the first portion of the communication channel and the parameters of a second tractable statistical distribution of the selected type and representative of the second portion of the communication channel, so as to form parametrized first and second tractable statistical distributions respectively defining the separate statistical models of the first and second portions of the communication channel;

wherein, to determine parameters of a type of tractable statistical distribution selected to represent both the first and second portions of the communication channel, the respective machine learning algorithms are configured to solve an optimization problem to minimize an objective function thereof based on a lower bound of a log-likelihood function of the received signal and including (i) a first divergence term representative of a statistical distance between a prior statistical distribution representative of the first portion of the communication channel and the separate statistical model of the first portion of the communication channel, (ii) a second divergence term representative of a statistical distance between a prior statistical distribution representative of the second portion of the communication channel and the separate statistical model of the second portion of the communication channel and (iii) a likelihood term based on a difference between the received signal and a reconstructed signal formed by the separate statistical models of the first and second portions of the communication channel; and

after forming the statistical model of the communication channel, determining, using the statistical model, the channel state information of the communication channel.

This provides an arrangement in which a statistical model of the communication channel, which is intractable, is approximated as plural tractable statistical distributions, one for each constituent portion of the communication channel, using variational inference-based machine learning.

In the illustrated arrangement, receiving, at one of the access point and the user device, a signal transmitted from another one of the access point and the user device comprises receiving, at the access point, a signal transmitted from the user device.

In the illustrated arrangement, the respective machine learning algorithms comprise neural networks.

In the illustrated arrangement, the first and second divergence terms are both of a Kullback-Leibler type.

In the illustrated arrangement, the type of tractable statistical distribution selected to represent both the first and second portions of the communication channel is one of Gaussian and Laplace.

### BRIEF DESCRIPTION OF THE DRAWINGS

The invention will be described in conjunction with the accompanying additional drawings in which:

FIG. 1 is a schematic diagram of a reconfigurable intelligent surfaces (RIS)-aided wireless communication system;

FIG. 2 is a diagram of variational neural networks;

FIG. 3 is a diagram of transmission protocol;

FIGS. 4A and 4B are graphs showing performance of a joint channel estimation (JCE) method in respect of achieved capacity and normalized mean square error (NMSE), respectively;

FIGS. 5A and 5B are graphs showing performance of JCE with different numbers of paths in respect of achieved capacity and NMSE, respectively;

FIG. 6 is a graph showing performance of novel methods proposed in this disclosure;

FIGS. 7A and 7B are graphs showing performance of a variational inference (VI)-based estimation of RIS-base station (BS) channel and user equipment (UE)-RIS channel covariance matrix in respect of achieved capacity and NMSE, respectively;

FIG. 8 is a graph showing inner product of the estimated largest eigenvectors with ground truth;

FIG. 9 is a graph showing performance of the estimates separated;

FIGS. 10A and 10B are graphs showing performance of joint channel covariance estimation (JCCE) versus the number of coherence blocks; and

FIG. 11 is a schematic diagram of a wireless communication network to which the method of the present invention may be applied.

In the drawings like characters of reference indicate corresponding parts in the different figures.

### DETAILED DESCRIPTION

Referring to the accompany figures, there is disclosed a fully passive reconfigurable intelligent surfaces (RIS) arrangement to separately estimate the user equipment (UE)-RIS and RIS-base station (BS) channels from the uplink training signals. From a Bayesian inference perspective, the main challenge is the acquisition of the posterior distribution of the separate channels because of the passive nature of the RIS. Therefore, a variational inference (VI)-based framework is used to provide an approximation of the intractable posterior distribution with convenient distributions. Diverging from conventional deterministic models, VI introduces a probabilistic paradigm that seamlessly integrates uncertainties allowing for the incorporation of prior information. It has been widely applied in channel estimation making use of the knowledge of the channels' prior [36]-[38]. A joint channel estimation (JCE) method, where the intractable posterior distribution of the UE-RIS and RIS-BS channels are approximated by auxiliary distributions that are convenient and tractable, is disclosed. The amortized VI framework where neural networks are used to map the training signals to the parameters of the auxiliary distributions is employed therein. These neural networks are trained through the minimization of the Evidence Lower Bound (ELBO) that represents the Kullback-Leibler (KL) divergence between the true posterior distribution of the channels and the auxiliary distributions. Then, using the predicted parameters, the maximum a posteriori (MAP) is used to estimate the channels.

Optimizing the phase-shifts according to the instantaneous CSI (I-CSI) can incur substantial signaling overhead at the RIS. This arises from the necessity to update the RIS configuration in each coherence block, particularly inconvenient when considering the rapid and dynamic changes of the UE-RIS channel. To reduce the signaling overhead, RIS-BS channel and UE-RIS channel covariance matrix (CCM) are used for passive beamforming, as they are slow-varying compared to the dynamic UE-RIS channel. Therefore, additionally is disclosed a joint channel-covariance estimation (JCCE) method that extends the use of the VI-based framework to directly estimate the RIS-BS channel and UE-RIS CCM from the received training signal at BS. This uses the VI-based framework to effectively approximate the posterior distributions of the RIS-BS channel and the UE-RIS CCM. Like the methodology applied in the joint channel estimation method, the auxiliary distributions, whose parameters are predicted by the neural networks, are leveraged to obtain the MAP estimates. Considering the large size of the UE-RIS CCM resulting from the large number of elements at the RIS, the inherent low-rank structure of the covariance of the mmWave channels is exploited. Differing from traditional methods, our approach directly estimates the UE-RIS CCM from the training signals, eliminating multiple intermediary channel estimation steps before the CCM computation. Also, unlike prior art in which the covariance matrix of the cascaded channel was estimated [35], the novel methodology estimates the RIS-BS channel and UE-RIS CCM separately. Also, the phase-shifts are derived in closed form, that maximize the capacity based on the RIS-BS channel and the UE-RIS CCM.

The novel methods are flexible and take into account the sparsity of mmWave channels as they do not use foreknowledge of the number of paths prior to the estimation process. The proposed solutions can also be extended to other types of channels. To summarize, teachings of the disclosure are as follows:
1. Using VI-based framework, the I-CSI in an RIS-aided mmWave systems with fully-passive RIS elements is separately estimated by searching for the auxiliary distributions that approximate the true posteriors of the channels.
2. The use of the VI-based estimation framework is extended to estimate the slow-varying RIS-BS channel and the UE-RIS CCM, which are used for RIS phase-shift optimization over several coherence blocks.
3. A closed-form expression for the phase-shifts that optimize the transmission capacity is developed, given the estimates of the RIS-BS channel and the UE-RIS CCM.
4. Effectiveness of the novel methods is demonstrated by comparing the achieved capacity with the capacity obtained using the perfect CSI. An improvement in spectral efficiency is shown while using the JCCE method compared to the JCE in addition to the substantial signal complexity reduction inherited by relying on the slow-varying RIS-BS channel and UE-RIS CCM for the passive beamforming.

The list of symbols that used hereinafter is given in Table 2. Scalars, vectors and matrices are denoted by x, x, and X, respectively. X* and X^{H} denote the complex conjugate and conjugate transpose of X. The i-th element of a vector x is xᵢ, while the (i,j)-th element of a matrix X is X_{i,j}. The n x n identity matrix is written as Iₙ. The diag(x) is the diagonal matrix with the elements of the vector a on the main diagonal. The element-wise product of X and Y is written as X∘Y, while the Khatri-Rao product between X and Y is written as X⊙Y. X⊗Y denotes the kronecker product between X and Y. Tr(X) and |X| represent the trace and determinant of the matrix X, respectively, and |x| represents the absolute value of a complex number x. The complex Gaussian random vector is denoted as x˜ [symbol] CN(m, Σ) with mean m and covariance matrix Σ, whereas a complex Laplace random variable x is denoted as x˜ [symbol] (m, b) with mean m, scale b and probability density function (PDF) given by:

$$p ( x ) = \frac{1}{2 π {b}^{2}} {e}^{- \frac{\vert x - m \vert}{b}} \qquad ( 1 )$$

A Gamma distributed random variable with unit scale is denoted as x˜Gamma(k) with shape k, while an Exponentially distributed random variable with rate α is denoted by x˜Exp(α).

### I. SYSTEM MODEL, ASSUMPTIONS AND VARIATIONAL INFERENCE APPROACH

### A. System Model, Assumptions and Methodology

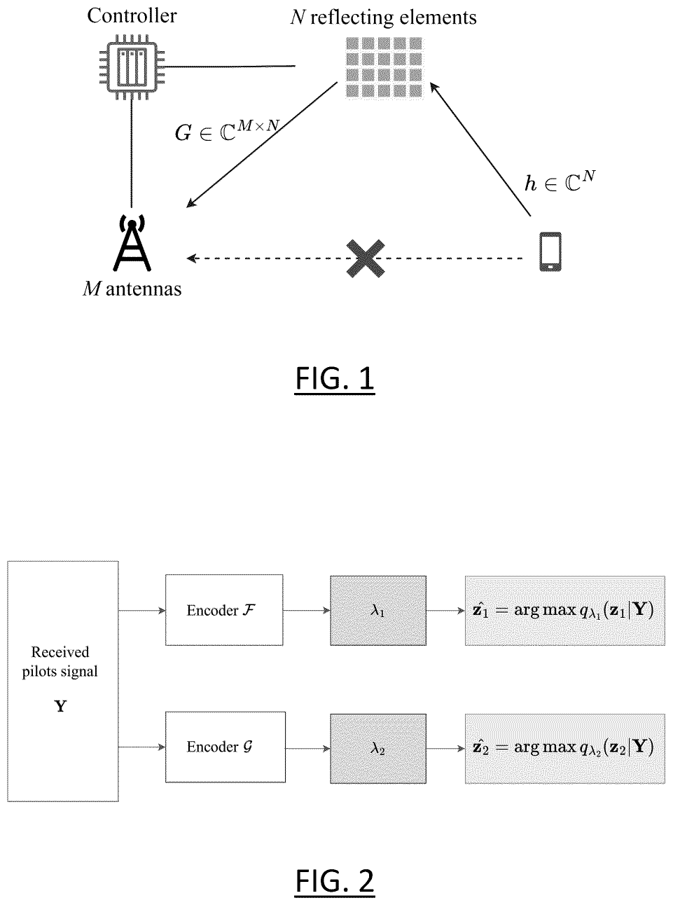

An RIS-assisted single-user communication system has M antennas at the BS, N passive reflecting elements at the RIS and a single-antenna user, as illustrated in FIG. 1. Considering the uplink transmission, the UE-RIS and RIS-BS channels are denoted by h∈ [symbol] ^{N} and G∈ [symbol] ^{M×N}, respectively. The direct connection between the user and the base station is blocked. Furthermore, a block-fading channel model where the RIS-related channels G and h are considered quasi-static within a coherence time denoted by T_{G} and Tₕ, respectively, is considered. Hence, the received signal at the BS can be expressed as follows:

$$y = \sqrt{ρ} G diag ( v ) h x + w , \qquad ( 2 )$$

where ρ, x∈ [symbol] , and w∈ [symbol] ^{M} are, respectively, the SNR, the transmitted signal, and the additive white noise, i.e., w˜ [symbol] (0,I_{M}). The phase shifts contributed by the RIS are represented by the diagonal matrix diag(v), where v=[e^{jθ}^{₁}, . . . , e^{jθ}^{_{N}}]^{T} with θₙ∈[0,2π) being the phase shift of the n-th element in the RIS.

To optimize the phase-shifts based on the I-CSI realizations, the VI technique is used to jointly estimate the channels between the UE and the RIS h, as well as between the RIS and the BS G, relying on the pilot transmissions in the uplink and the sparse structure of the channels.

Although the use of the instantaneous channels may lead to optimal phase shift configuration, it is a challenging task in practice. First, the coherence time of the mmWave channels can be drastically shorter than that in sub-6 GHz channels [28], in particular for high mobile users. Hence, the channel estimation and phase optimization are performed repeatedly after every Tₕ<<T_{G}, which will entail a significant amount of training overhead and tremendous computational resources accompanied by spectral inefficiency due to the pilots sent in each coherence block. Furthermore, the system optimization based on the I-CSI requires frequent transmissions of control signals from the BS to the RIS, which involves a considerable amount of signaling overhead. Therefore, to mitigate the overhead due to the traditional channel estimation approaches, one promising direction for the RIS phase-shift design is to use only the S-CSI of the UE-RIS channel that is considered wide-sense stationary with an invariant covariance Rₕ= [symbol] [hh^{H}], and the RIS-BS channel which remains quasi-static given the static positions of the RIS and the BS. Therefore, no frequent updates will be required, thus reducing the signaling overhead and enhancing the efficiency of the RIS-aided communication system.

Hereinafter, the VI-based approach is described further, used to solve the joint RIS-BS and UE-RIS channel estimation, and the joint RIS-BS channel and UE-RIS CCM estimation problems in an RIS-aided mmWave wireless communication system.

### B. Variational Inference (VI) Approach

The variational methods are a class of systematic approaches that approximate complex and intractable probability distributions with convenient tractable ones. VI is a specific case of variational methods that infers the marginal distributions or likelihood functions of hidden variables in a statistical model [40], [41]. For instance, for a communication model with two unknown inputs denoted z₁ and z₂ (e.g., RIS-BS and UE-RIS channels) and an observed output Y, the output is assumed to be obtained following a certain probability p(Y|z₁, z₂). If the goal is to infer {z₁, z₂} based on the evidence Y, there is interest in deriving the probability p(z₁, z₂|Y). When the direct evaluation of the posterior distribution p(z₁, z₂|Y) is infeasible, VI permits approximation of the posterior p(z₁, z₂|Y) with a parameterized tractable distribution q_{λ}(z₁, z₂|Y).

The central concept in VI is the Evidence Lower Bound (ELBO), also known as the variational lower bound. It serves as a surrogate for the intractable log-likelihood of the data, and maximizing it corresponds to minimizing the Kullback-Leibler (KL) divergence between the true posterior p(z₁, z₂|Y) and the variational approximation q_{λ}(z₁, z₂|Y). The ELBO is given by [42]:

$$log p ( Y ) \geq {𝔼}_{{z}_{1} , {z}_{2} ∼ {q}_{λ} ( {z}_{1} , {z}_{2} \vert Y )} [ log \frac{p ( {z}_{1} , {z}_{2} , Y )}{{q}_{λ} ( {z}_{1} , {z}_{2} \vert Y )} ] \hat{=} - ℒ ( Y ; λ ) . \qquad ( 3 )$$

Assuming that q_{λ}(z₁, z₂|Y) belongs to a family of tractable distributions, the VI approach optimizes the parameters λ of the approximated distribution q_{λ}(z₁, z₂|Y) such that the objective function [symbol] (Y; λ) is minimized.

Furthermore, it is assumed that the approximated distribution can be factorized as q_{λ}(z₁, z₂|Y)=q_{λ}_{₁}(z₁|Y)·q_{λ}_{₂} (z₂|Y) where λ=(λ₁, λ₂) and the independent distributions is optimized by minimizing [symbol] (Y; λ₁, λ₂). This independence assumption is referred to as the mean-field approximation [41]. It is equivalent to assuming a low correlation between z₁ and z₂ conditioned on Y. Hence, the objective function is simplified to a general form given by:

$$ℒ ( Y ; {λ}_{1} , {λ}_{2} ) = {\underbrace{{𝔼}_{{z}_{1} ∼ {q}_{{λ}_{1}} ( {z}_{1} \vert Y )} [ log \frac{{q}_{{λ}_{1}} ( {z}_{1} \vert Y )}{p ( {z}_{1} )} ]}}_{{ℒ}_{1}} + {\underbrace{{𝔼}_{{z}_{2} ∼ {q}_{{λ}_{2}} ( {z}_{2} \vert Y )} [ log \frac{{q}_{{λ}_{2}} ( {z}_{2} \vert Y )}{p ( {z}_{2} )} ]}}_{{ℒ}_{2}} - {\underbrace{{𝔼}_{{z}_{1} , {z}_{2} ∼ {q}_{λ} ( {z}_{1} , {z}_{2} \vert Y )} [ log p ( Y \vert {z}_{1} , {z}_{2} ) ]}}_{{ℒ}_{3}} . \qquad ( 4 )$$

Note that [symbol] ₁ and [symbol] ₂ in Eq. (4) represent the KL divergence between the auxiliary distributions, also known as variational distributions, q_{λ}_{₁}(z₁|Y) and q_{λ}_{₂}(z₂|Y) and their actual priors p(z₁) and p(z₂), respectively. Regarding [symbol] ₃, it corresponds to the reconstruction error of the estimated pilot signal Ŷ with the auxiliary distributions q_{λ}_{₁}(z₁|Y) and q_{λ}_{₂}(z₂|Y). Hence, minimizing the objective function [symbol] = [symbol] ₁+ [symbol] ₂+ [symbol] ₃ ensures that the generated posterior distributions are close to the prior distributions and the reconstructed signal Ŷ is similar to the received signal.

After deriving the ELBO, one common approach is to use neural networks to parameterize the approximate posterior distribution [43]. In this approach, a neural network is used to map the observed data to the parameters of the auxiliary distribution, such as the mean and the scale parameters of a complex Laplace distribution. The neural network is typically trained using stochastic gradient descent or a related optimization algorithm to minimize the KL divergence between the auxiliary distribution and the true posterior distribution, as represented by the ELBO.

Therefore, the parameters of the two auxiliary distributions q_{λ}_{₂}(z₂|Y) and q_{λ}_{₁}(z₁|Y) by two trainable neural networks are:

$${λ}_{1} = {ℱ}_{{𝒲}_{1}} ( Y ) ; {λ}_{2} = {𝒢}_{{𝒲}_{2}} ( Y ) \qquad ( 5 )$$

referred to by Encoder [symbol] and Encoder [symbol] as shown in FIG. 2, where [symbol] ₁ and [symbol] ₂ are the weights of the neural networks. In particular, the neural networks take the training signal Y which is the observed data as input and outputs the parameters of the distributions q_{λ}_{₁}(z₁|Y) and q_{λ}_{₂}(z₂|Y). The neural networks learn to encode the data into a meaningful representation that captures the latent information. The parameters of the two neural networks Encoder [symbol] and Encoder [symbol] are learned by minimizing the ELBO in Eq. (4):

$${𝒲}_{1}^{*} , {𝒲}_{2}^{*} = arg {min}_{{𝒲}_{1} , {𝒲}_{2}} ℒ ( Y ; {ℱ}_{{𝒲}_{1}} ( Y ) ; {𝒢}_{{𝒲}_{2}} ( Y ) ) \qquad ( 6 )$$

### II. CSI ESTIMATION VIA VARIATIONAL INFERENCE

The channel information of the RIS-BS and the UE-RIS links in an RIS-aided mmWave wireless communication system with fully-passive elements are separately estimated, using the uplink training signals. First, the I-CSI for RIS-BS and UE-RIS links are separately estimated. Second, the RIS-BS channel and the UE-RIS CCM are separately estimated.

### III. JOINT CHANNEL ESTIMATION VIA VARIATIONAL INFERENCE

The RIS-BS channel G and the UE-RIS channel h are estimated based on the received training signal. The training signal is obtained by sending Nₚ pilot signals by the user to the BS through the UE-RIS-BS channel. For different transmissions, different configurations of the RIS are maintained for each pilot signal, denoted by vₗ. The received training signals are given by:

$$Y = \sqrt{ρ} G ( Φ ∘ ( {hx}^{T} ) ) + W , \qquad ( 7 )$$

where Y=y₁, . . . , y_{N}_{ₚ} ∈ [symbol] ^{M×N}^{ₚ} is the concatenation of the Nₚ training signals, x=[x₁, . . . , x_{N}_{ₚ}]^{T} denotes the pilots sent by the user, Φ=[v₁, . . . , n_{N}_{ₚ}] is concatenation of the phase-shifts vectors used where vₗ is assigned to the l-th pilot signal, and W=[w₁, . . . , w_{N}_{ₚ}] is the noise matrix.

In mmWave communication and due to the large number of elements in the RIS and the high path loss, the channels are sparse in the angular domain [3]. Specifically, only a small number of paths contribute to the received signal, and the other paths are negligible. The channels in the angular can be obtained by applying the Discrete Fourier Transform (DFT) as follows:

$${G}^{vir} = {F}_{M} G {F}_{N} ; {h}^{vir} = {F}_{N} h , \qquad ( 8 )$$

where F_{N} and F_{M} are the DFT matrices of size N×N and M×M, respectively. G^{vir} and h^{vir} are the channels in the angular domain where the elements are independent and identically distributed and distributed according to a complex Laplace distribution with zero mean and scales α_{G}_{^{vir}} and αₕ_{^{vir}}, respectively, i.e., G_{i,j}^{vir}˜ [symbol] (0, α_{G}_{^{vir}}) and hᵢ^{vir}˜ [symbol] (0, αₕ_{^{vir}}). Given that

$${F}_{N}^{- 1} = \frac{1}{N} {F}_{N}^{H}$$

for any DFT matrix of size N×N, the received training signal for the l-th time slot is expressed as follows:

$${y}_{l} = \frac{\sqrt{ρ}}{M {N}^{2}} {F}_{M}^{H} {G}^{vir} {F}_{N}^{H} diag ( {v}_{l} ) {F}_{N}^{H} {h}^{vir} {x}_{l} + {w}_{l} , l = 1 , … , {N}_{p} . \qquad ( 9 )$$

By applying the VI framework, the intractable true posterior distribution p(h^{vir}, G^{vir}|Y) is approximated by a tractable parameterized distribution denoted q_{λ}(h^{vir}, G^{vir}|Y) that minimizes the ELBO function. Assuming a low-correlation between the channels h^{vir} and G^{vir} conditioned on the training signal Y, by using the mean-field approximation, the auxiliary distribution is factorized as q_{λ}(h^{vir}, G^{vir}|Y)=q_{λ}_{₁}(h^{vir}|Y). q_{λ}_{₂}(G^{vir}|Y).

The auxiliary distributions is assumed to follow complex Laplace distributions with independent elements:

$${q}_{{λ}_{1}} ( {h}_{i}^{vir} \vert Y ) ∼ 𝒞ℒ ( {m}_{i , j} , {b}_{i} ) ∀ i ; \qquad ( 10 ) , ( 11 )$$

$${q}_{{λ}_{2}} ( {G}_{i , j}^{vir} \vert Y ) ∼ 𝒞ℒ ( {M}_{i , j} , {B}_{i , j} ) ∀ i , j ,$$

where λ₁={m, b} and λ₂={M, B} are the parameters of the auxiliary distributions where the optimal values minimize the ELBO function expressed as follows:

$${ℒ}^{I - CSI} ( {λ}_{1} , {λ}_{2} ) = {{𝔼}_{{h}^{v i r} ∼ {q}_{{λ}_{1}} ( {h}^{v i r} \vert Y )} [ log \frac{{q}_{{λ}_{1}} ( {h}^{vir} \vert Y )}{p ( {h}^{vir} )} ]}_{\underbrace{{ℒ}_{1}^{I - CSI}}} + {{𝔼}_{{G}^{v i r} ∼ {q}_{{λ}_{2}} ( {G}^{v i r} \vert Y )} [ log \frac{{q}_{{λ}_{2}} ( {G}^{vir} \vert Y )}{p ( {G}^{vir} )} ]}_{\underbrace{{ℒ}_{2}^{I - CSI}}} - {{𝔼}_{{h}^{v i r} , {G}^{v i r} ∼ {q}_{λ} ( {h}^{v i r} , {G}^{v i r} \vert Y )} [ log p ( Y \vert {h}^{vir} , {G}^{vir} ) ]}_{\underbrace{{ℒ}_{3}^{I - CSI}}} . \qquad ( 12 )$$

$${ℒ}_{3}^{I - CSI} ( λ ) = - {Σ}_{l = 1}^{{N}_{p}} {𝔼}_{{h}^{v i r} , {G}^{v i r} ∼ {q}_{λ} ( {h}^{v i r} , {G}^{v i r} \vert Y )} [ log p ( {y}_{l} \vert {h}^{vir} , {G}^{vir} ) ] = {Σ}_{l = 1}^{{N}_{p}} [ {( {y}_{l} - \frac{\sqrt{ρ}}{M {N}^{2}} {F}_{M}^{H} M {F}_{N}^{H} diag ( {v}_{l} ) {F}_{N}^{H} m {x}_{l} )}^{H} ( {y}_{l} - \frac{\sqrt{ρ}}{M {N}^{2}} {F}_{M}^{H} M {F}_{N}^{H} diag ( {v}_{l} ) {F}_{N}^{H} m {x}_{l} ) + \frac{ρ {\vert {x}_{l} \vert}^{2}}{M {N}^{4}} \cdot Tr ( Λ {F}_{N}^{H} diag ( {v}_{l} ) {F}_{N}^{H} Q {F}_{N} {diag ( {v}_{l} )}^{H} {F}_{N} ) + \frac{ρ {\vert {x}_{l} \vert}^{2}}{M {N}^{4}} T r ( {M}^{H} M {F}_{N}^{H} diag ( {v}_{l} ) {F}_{N}^{H} Q {F}_{N} {diag ( {v}_{l} )}^{H} {F}_{N} ) + \frac{ρ {\vert {x}_{l} \vert}^{2}}{M {N}^{4}} {m}^{H} {F}_{N} {diag ( {v}_{l} )}^{H} {F}_{N} Λ {F}_{N}^{H} diag ( {v}_{l} ) {F}_{N}^{H} m ] + {C}_{1} . \qquad ( 13 )$$

The first loss [symbol] ₁^{I-CSI} is the KL-divergence between the auxiliary distribution and the prior of h^{vir}, which can be expressed as follows:

$${ℒ}^{I - CSI} ( {λ}_{1} ) = {\sum }_{i = 1}^{N} {𝔼}_{{h}_{i}^{vir} ∼ {q}_{{λ}_{1}} ( {h}_{i}^{vir} \vert Y )} [ log {q}_{{λ}_{1}} ( {h}_{i}^{vir} \vert y ) ] - {𝔼}_{{h}_{i}^{vir} ∼ {q}_{{λ}_{1}} ( {h}_{i}^{vir} \vert Y )} [ log p ( {h}_{i}^{vir} ) ] = {\sum }_{i = 1}^{N} H ( {q}_{{λ}_{1}} ( {h}_{i}^{vir} \vert Y ) , p ( {h}_{i}^{vir} ) ) - H ( {q}_{{λ}_{1}} ( {h}_{i}^{vir} \vert Y ) ) \qquad ( 14 )$$

where H(q_{λ}_{₁}(hᵢ^{vir}|Y)) is the entropy of q_{λ}_{₁}(hᵢ^{vir}|Y) and H^{cross-entropy}=H(q_{λ}_{₁}(hᵢ^{vir}|Y), p(hᵢ^{vir}) is the cross entropy between q_{λ}_{₁}(hᵢ^{vir}|Y) and p(hᵢ^{vir}). The entropy of the complex Laplace distribution is:

$$H ( {q}_{{λ}_{1}} ( {h}_{i}^{vir} \vert Y ) = log ( 2 π {b}_{i}^{2} ) + 2. \qquad ( 15 )$$

The proof can be found in the section entitled ‘Supplementary Material’. he cross-entropy between two complex Laplace distributions can be obtained by using the Monte-Carlo method to approximate the expectation over h^{vir}. Therefore, it is given by:

$${H}^{c r oss - entropy} = log ( 2 π {α}_{{h}^{v i r}}^{2} ) + {𝔼}_{{h}_{i}^{v i r} ∼ {q}_{{λ}_{1}} ( {h}_{i}^{v i r} \vert Y )} [ \frac{\vert {h}_{i}^{vir} \vert}{{α}_{{h}^{v i r}}} ] \approx log ( 2 π {α}_{{h}^{v i r}}^{2} ) + \frac{1}{D} {\sum }_{d = 1}^{D} \frac{\vert \vert}{{α}_{{h}^{v i r}}} ,$$

where the d-th sample is computed as [symbol] =mᵢ+bᵢ× [symbol] (0,1). Hence, [symbol] ₁^{I-CSI} is expressed as:

$${ℒ}_{1}^{I - CSI} ( {λ}_{1} ) = \frac{1}{D} {\sum }_{i = 1}^{N} {\sum }_{d = 1}^{D} \frac{\vert \vert}{{α}_{{h}^{vir}}} - {\sum }_{i = 1}^{N} log ( 2 π {b}_{i}^{2} ) + N log ( 2 π {α}_{{h}^{vir}}^{2} ) - 2 N . \qquad ( 17 )$$

Similarly, [symbol] ₂^{I-CSI} is derived as:

$${L}_{2}^{I - CSI} ( {λ}_{2} ) = \frac{1}{D} {\sum }_{i = 1}^{M} {\sum }_{j = 1}^{N} {\sum }_{d = 1}^{D} \frac{\vert \vert}{{α}_{{G}^{vir}}} - {\sum }_{i = 1}^{M} {\sum }_{j = 1}^{N} log ( 2 π {B}_{i , j}^{2} ) + NM log ( 2 π {α}_{{G}^{vir}}^{2} ) - 2 N M , \qquad ( 18 )$$

where the Monte-Carlo samples are computed as [symbol] =M_{i,j}+B_{i,j}× [symbol] (0,1). The third loss consists of the expectation over the auxiliary distributions of the log-likelihood of the received training signal. It can be derived in closed-form as in Eq. (13), where C₁ is a constant, Q and ∧ are the covariance matrix over the columns of G^{vir} and covariance matrix of h^{vir}, respectively, which are diagonal matrices due to the independence of the elements according to the auxiliary distributions. The main diagonal elements are as follows (see the proof in the section entitled ‘Supplementary Material’):

$${Λ}_{i , i} = 6 {b}_{i}^{2} ; {Q}_{i , i} = 6 {\sum }_{m = 1}^{M} {B}_{m , i}^{2} . \qquad ( 19 )$$

The parameters m, b, M and B of the auxiliary distributions are obtained using the variational neural networks, as shown in Eq. (5). Specifically, Encoder [symbol] is used to characterize q_{λ}_{₁}(h^{vir}|Y) and Encoder [symbol] is used for q_{λ}_{₂} (G^{vir}|Y), i.e., m and b are the output of Encoder [symbol] and M and B are the output of Encoder [symbol] . The training signal Y is fed to the encoders as input and the encoders' outputs are the parameters that minimize the ELBO. Given that the training signals involve complex numbers and neural networks typically operate with real-valued inputs, the input is preprocessed by splitting it into its real and imaginary components. Subsequently, these components are concatenated before being fed into the neural networks. A similar approach is applied to the means of the auxiliary distributions. The output yields both the real and complex parts of the means, which are then used to reconstruct the complex numbers represented by m and M.

### IV. JOINT CHANNEL-COVARIANCE ESTIMATION VIA VARIATIONAL INFERENCE

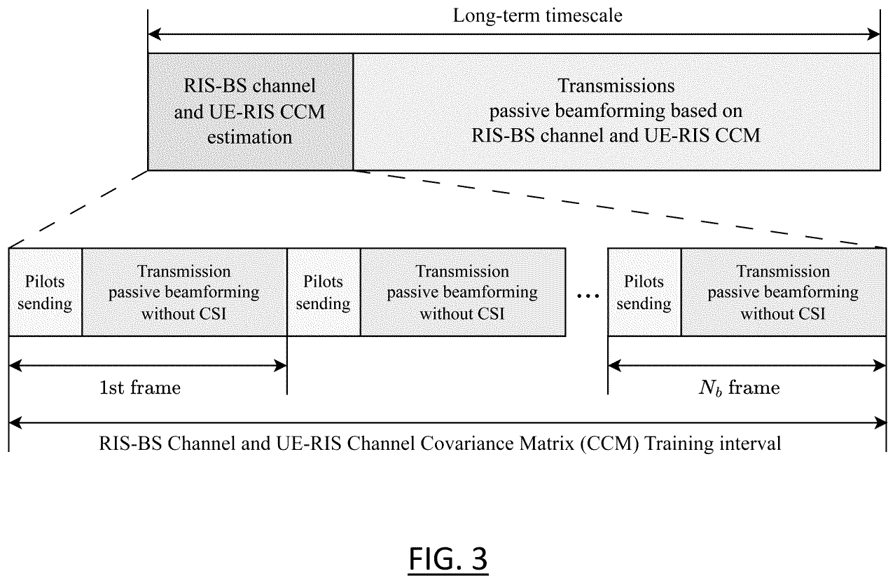

1) Uplink training: To reduce the signaling overhead of the RIS, the slow-varying property of the i) RIS-BS channel as the physical locations of the RIS and BS do not change over time, and ii) the UE-RIS CCM, are exploited to perform the passive beamforming. A transmission protocol is disclosed to effectively estimate the RIS-BS channel and the UE-RIS CCM, as shown in FIG. 3. Within the considered time interval, referred to as long-term timescale, the UE-RIS channel varies following the covariance matrix denoted by Rₕ that remains invariant same as the RIS-BS channel. In alignment with the two-timescale training protocol outlined in [35], the approach herein involves dual-phase channel training process. In the initial phase, the focus is on estimating the RIS-BS channel and the UE-RIS CCM. Then, the phase-shifts are optimized based on these estimates. Thus, the second phase is dedicated to transmissions where the optimized phase-shifts are fixed, and the channel estimation process focuses on estimating the M×1 low-dimension UE-RIS-BS effective channel alongside the data transmission. Focusing on the initial phase, the considered interval is divided into N_{b} coherence blocks of the UE-RIS channel h wherein the first Nₚ time slots are used to send the training symbols, resulting in a total of Nₚ×N_{b} slots allocated for pilots transmission. To directly estimate Rₕ from the training signal, the training signal encompasses diverse realizations of h. The remaining time slots in each h coherence block are then dedicated to transmissions, employing passive beamforming without CSI schemes such as in [44].

In the s-th UE-RIS coherence block, by sending N_{P} pilot signals while altering the configuration for each pilot, the received signal at the BS can be expressed as:

$${Y}_{s} = \sqrt{ρ} G diag ( {h}_{s} ) Φ + W , s = 1 , … , {N}_{b} \qquad ( 20 )$$

where hₛ is the UE-RIS channel during the s-th coherence block, Φ[v₁, . . . , v_{N}_{ₚ}]∈ [symbol] ^{N×N}^{ₚ} is the RIS configuration used for training, W=[w₁, . . . , w_{N}_{ₚ}] is the noise matrix where wₗ˜ [symbol] (0, I_{N}). The vectorized form of Yₛ can be expressed as follows:

$${\tilde{y}}_{s} = vec ( {Y}_{s} ) = \sqrt{ρ} ( {Φ}^{T} ⊙ G ) {h}_{s} + w , \qquad ( 21 )$$

where w=vec(W)˜ [symbol] (0,I_{MN}_{ₚ}). The combined training received signal is defined as \tilde{Y}=[\tilde{y}₁, . . . , \tilde{y}_{N}_{_{b}}] The covariance matrix of the received training signal \tilde{y}ₛ, given that the RIS-BS channel remains quasi-static, is expressed as:

$${R}_{\tilde{y}} = 𝔼 [ {\tilde{y}}_{s} {\tilde{y}}_{s}^{H} ] = ρ ( {Φ}^{T} ⊙ G ) {{R}_{h} ( {Φ}^{T} ⊙ G )}^{H} + {I}_{M {N}_{p}} . \qquad ( 22 )$$

In various scenarios, the UE-RIS channel is highly correlated because of the small set of angles of arrivals (AoAs) contributing to the propagation [39]. Therefore, the covariance matrix Rₕ= [symbol] [hh^{H}] is considered as a low-rank matrix. Formally, the covariance matrix is expressed as follows:

Rₕ=F_{N}^{H}DF_{N}, (23)

where D=diag(d) is a diagonal matrix with a sparse main diagonal denoted as d. The focus is on estimating the sparse vector d, rather than estimating the full covariance matrix Rₕ which is typically a large matrix of size N×N, and the RIS-BS channel in the angular domain denoted as G^{vir}=F_{M}GF_{N}.
2) Derivation of ELBO: As previously described, the channel between the RIS and the BS exhibits sparsity in the angular domain. The complex Laplace distribution is employed to model the sparse matrix G^{vir}. Additionally, the vector d, which represents a sparse positive real-valued vector, is modeled using a complex Exponential distribution:

$${G}_{i , j}^{vir} ∼ 𝒞ℒ ( 0 , {α}_{{G}^{v i r}} ) ; {d}_{i} ∼ Exp ( {α}_{d} ) . \qquad ( 24 )$$

Applying the VI framework, the intractable true posterior distribution p(G^{vir}, d|\tilde{Y}) is approximated by two separate tractable parameterized distributions denoted by q_{λ}_{₁}(d|\tilde{Y}) and q_{λ}_{₂}(G^{vir}|\tilde{Y}) using the mean-field approximation. Moreover, the parameters of the chosen auxiliary distributions are returned by Encoder [symbol] and Encoder [symbol] . The training signal \tilde{Y} is preprocessed such that the input to the neural networks is defined by \tilde{Y}\tilde{Y}^{H}/N_{b}−I_{MN}_{ₚ}.

The auxiliary distribution for the RIS-BS channel in the angular domain G^{vir} is assumed to follow the complex Laplace distribution with independent elements, and the elements of d follow a Gamma distribution with unit scale:

$${q}_{{λ}_{1}} ( {d}_{i} \vert \tilde{Y} ) ∼ Gamma ( {k}_{i} ) ; \qquad ( 25 )$$

$${q}_{{λ}_{2}} ( {G}_{i , j}^{vir} \vert \tilde{Y} ) ∼ 𝒞ℒ ( {M}_{i , j} , {B}_{i , j} ) , \qquad ( 26 )$$

where λ₁={k} and λ₂={M, B} are the parameters of the auxiliary distributions which are obtained by minimizing the ELBO function, which is given in general form in Eq. (4) expressed as follows:

$${ℒ}^{S - CSI} ( {λ}_{1} , {λ}_{2} ) = {\underbrace{{𝔼}_{d ∼ {q}_{{λ}_{1}} ( d \vert Y )} [ log \frac{{q}_{{λ}_{1}} ( d \vert \tilde{Y} )}{p ( d )} ]}}_{{ℒ}_{1}^{S - CSI}} + {\underbrace{{𝔼}_{{G}^{vir} ∼ {q}_{{λ}_{2}} ( {G}^{vir} \vert \tilde{Y} )} [ log \frac{{q}_{{λ}_{2}} ( {G}^{vir} \vert \tilde{Y} )}{p ( {G}^{vir} )} ]}}_{{ℒ}_{2}^{S - CSI}} - {\underbrace{{𝔼}_{d , {G}^{vir} ∼ {q}_{λ} ( d , {G}^{vir} \vert \tilde{Y} )} [ logp ( \tilde{Y} \vert d , {G}^{vir} ) ]}}_{{ℒ}_{3}^{S - CSI}} . \qquad ( 27 )$$

Since the prior and the auxiliary posterior of G^{vir} align with the case addressed in the joint channel estimation, the second loss, expressed as [symbol] ₂^{S-CSI} [symbol] ₂^{I-CSI}, remains unchanged. However, the first loss, which involves the KL-divergence between an Exponential distribution and a Gamma distribution, can be expressed as follows:

$$\begin{matrix}{ℒ}_{1}^{S - CSI} ( {λ}_{1} ) = {𝔼}_{d ∼ {q}_{{λ}_{1}} ( d \vert \tilde{Y} )} [ log \frac{{q}_{{λ}_{1}} ( d \vert \tilde{Y} )}{p ( d )} ] \\ = {\sum }_{i = 1}^{N} {𝔼}_{d ∼ {q}_{{λ}_{1}} ( {d}_{i} \vert \tilde{Y} )} [ log q ( {d}_{i} \vert \tilde{Y} ) - log p ( {d}_{i} ) ] \\ = {\sum }_{i = 1}^{N} ( 1 - {k}_{i} ) ψ ( 1 ) - log Γ ( 1. ) + log Γ ( {k}_{i} ) ,\end{matrix} \qquad ( 28 )$$

where Γ(x) is the gamma function and ψ(x) is the digamma function. The third loss, denoted as [symbol] ₃^{S-CSI}, is defined as the log-likelihood of the received training signal and can be expressed as follows:

$${ℒ}_{3}^{S - CSI} ( {λ}_{1} , {λ}_{2} ) = {𝔼}_{d , {G}^{vir} ∼ {q}_{λ} ( d , {G}^{vir} \vert \tilde{Y} )} [ Tr ( {\tilde{Y}}^{H} {R}_{\tilde{Y}}^{- 1} \tilde{Y} ) + log \vert {R}_{\tilde{Y}} \vert ] + {C}_{2} , \qquad ( 29 )$$

where C₂ is a constant. To compute the gradient with respect to the parameters of the auxiliary distribution of the RIS-BS channel link, q_{λ}_{₂}(G^{vir}|\tilde{Y}), the reparameterization trick is employed. This technique involves generating Monte-Carlo samples where each sample is computed by [symbol] _{i,j}=M_{i,j}+B_{i,j}× [symbol] (0,1) to maintain the differentiability and enabling efficient optimization through gradient-based methods. To address the complexity of directly applying the standard reparameterization trick to the Gamma distribution, an alternative technique known as the implicit reparameterization technique, as outlined by [45], is employed. This technique facilitates the generation of Monte-Carlo samples that remain differentiable with respect to the shape parameter vector k.

After training the neural networks, denoted as Encoder [symbol] and Encoder [symbol] , that predict the distribution parameters k and {M,B} of q_{λ}_{₁} (d|\tilde{Y}) and q_{λ}_{₂}(G^{vir}|\tilde{Y}), respectively, the channels are estimated using the MAP method applied on the auxiliary distributions:

$$\hat{d} = arg {max}_{d} {q}_{{λ}_{1}} ( d \vert \tilde{Y} ) = k - 1 ; \qquad ( 30 )$$

$$= arg {max}_{{G}^{vir}} {q}_{{λ}_{2}} ( {G}^{v i} \vert \tilde{Y} ) = M . \qquad ( 31 )$$

### V. OPTIMIZATION OF RIS PHASE SHIFTS

The primary evaluation metric is the capacity of the RIS-assisted network obtained after deriving the phase-shifts based on the estimated quantities. Therefore, closed-form expressions are derived of the phase-shifts of the RIS that maximize the capacities for the two cases of channel information considered: the RIS-BS and the UE-RIS channels, and the RIS-BS channel and the UE-RIS CCM.

### A. Instantaneous CSI

For the considered uplink RIS-assisted mmWave system, the received signal at the BS can be expressed as follows:

$$y = \sqrt{ρ} G diag ( v ) h x + w , \qquad ( 32 )$$

where x is the transmitted symbol satisfying [symbol] (|x|²)=1, ρ is the SNR, and w˜ [symbol] (0, I_{M}) denotes the additive white noise. The ergodic capacity is expressed by:

$$C = {log}_{2} ( 1 + ρ \vert \vert G diag ( v ) h {\vert \vert}_{2}^{2} ) . \qquad ( 33 )$$

Based on the I-CSI, i.e., h and G, the phase-shifts are configured to maximize the capacity C, which is equivalent to solving the following problem:

$${max}_{\{ {θ}_{i} \}} \vert \vert G diag ( v ) h {\vert \vert}_{2}^{2} \qquad ( 34 )$$

$$Subject to : {v}_{i} = {e}^{j {θ}_{i}} .$$

Given the singular value decomposition (SVD) of G=USV^{H}, the problem is equivalent

$$to maximizing \vert \vert {SV}^{H} diag ( v ) h {\vert \vert}_{2}^{2} which is expressed as follows :$$

$$\begin{matrix}\vert \vert {SV}^{H} diag ( v ) h {\vert \vert}_{2}^{2} = {\sum }_{i = 1}^{r} {\vert {\sum }_{k = 1}^{N} {s}_{i} {V}_{ki}^{*} {h}_{k} {v}_{k} \vert}^{2} \\ {= {\sum }_{i = 1}^{r} \vert {\sum }_{k = 1}^{N} {s}_{i} \vert {V}_{ki} \vert \vert {h}_{k} \vert {e}^{j ( {θ}_{k} - ∠ {V}_{ki} + {∠h}_{k}} ) \vert}^{2} .\end{matrix} \qquad ( 35 )$$

where r is the rank of G and sᵢ are the singular values in the descending order of G. A solution is to align the phase-shifts θₖ to the phases of the largest right singular vector of G, denoted as ϑ^{max}, and the phases of the channel vector h. Specifically, the suboptimal phase-shifts are obtained as follows:

$${θ}_{k}^{*} = - ( ∠ {h}_{k} - {∠ϑ}_{k}^{max} ) . \qquad ( 36 )$$

### B. RIS-BS I-CSI AND UE-RIS S-CSI

A closed-form expression of the phase-shifts that maximize the achievable rate of the UE-RIS-BS link based on the I-CSI of RIS-BS channel and the S-CSI (i.e., channel covariance matrix) of the UE-RIS channel, is disclosed. The problem is formulated as follows:

$${max}_{\{ {θ}_{i} \}} {𝔼}_{h} [ {log}_{2} ( 1 + ρ \vert \vert G diag ( v ) h {\vert \vert}_{2}^{2} ) , \qquad ( 37 )$$

$$Subject to : {v}_{i} = {e}^{{θ}_{i}} .$$

The problem in Eq. (37) is challenging to solve due to the lack of an explicit expression for the expectation over the logarithm. A strategy of maximizing a reliable upper bound on this expression [32] is adopted to address this difficulty:

$${𝔼}_{h} [ {log}_{2} ( 1 + ρ \vert \vert G diag ( v ) h {\vert \vert}_{2}^{2} ) ] \leq {log}_{2} ( 1 + ρ {𝔼}_{h} [ \vert \vert G diag ( v ) h {\vert \vert}_{2}^{2} ) . \qquad ( 38 )$$

The upper bound in Eq. (38) is highly accurate and serves as a reliable approximation of the original objective function, particularly for large values of ρ [32]. To maximize this upper bound, the subsequent optimization problem is formulated as follows:

$${max}_{\{ {θ}_{i} \}} {𝔼}_{h} [ \vert \vert G diag ( v ) h {\vert \vert}^{2} ] , \qquad ( 39 )$$

$$Subject to : {v}_{i} = {e}^{{θ}_{i}} .$$

The objective can be further expressed as follows:

$${𝔼}_{h} [ ( \vert \vert G diag ( v ) h {\vert \vert}^{2} ) ] = Tr ( G diag ( v ) {R}_{h} {diag ( v )}^{H} {G}^{H} ) . \qquad ( 40 )$$

Given the SVD of G=USV^{H} and the eigenvalue decomposition of the covariance matrix Rₕ=PΣP^{H}, the objective function can be expressed as follows:

$${𝔼}_{h} [ ( \vert \vert G diag ( v ) h {\vert \vert}^{2} ) ] = {\sum }_{i = 1}^{r} {\sum }_{i = 1}^{r} {\vert {S}_{i} \sqrt{{o}_{j}} {\sum }_{i = 1}^{N} {V}_{k , i}^{*} {P}_{k , j} {e}^{i {θ}_{k}} \vert}^{2} \qquad ( 41 )$$

where r′ is the rank of Rₕ and σⱼ are the eigenvalues in the descending order. Therefore, The phases that align with the phases of the largest eigenvector of G and Rₕ, referred to as ϑ^{max} and p^{max}, respectively, are taken to maximize the objective function and satisfy the unit modulus constraints, which are given by:

$${θ}_{k}^{*} = - ( ∠ {p}_{k}^{m ax} - {∠ϑ}_{k}^{m ax} ) .$$

### VI. SIMULATION AND RESULTS

The performance of the two proposed CSI estimation methods was evaluated in RIS-aided SIMO mmWave wireless communication systems. The first approach to estimate the I-CSI is referred to as joint channel estimation (JCE) and the second method is referred to as joint channel and covariance Estimation (JCCE). In the example for evaluating performance, the setup of M=4 antennas at the BS and N=64 passive elements at the RIS is considered.

### A. Evaluation Metrics and Baselines

One evaluation metric is the capacity of the RIS-aided SIMO communication system. The estimated quantities, specifically the UE-RIS and RIS-BS channels for JCE, and the UE-RIS CCM and the estimated instantaneous RIS-BS channel gains for JCCE are leveraged to calculate the phase-shifts and determine the achieved capacity defined as C=log₂(1+ρ∥G diag(v) h∥²). Moreover, the normalized mean square error (NMSE) defined by NMSE=∥\hat{X}−X∥²/∥X∥₂² is evaluated, where Frobenius norm is used for matrices and l₂ norm is used for vectors.

The methodologies are compared against the following baselines:
Perfect CSI: this is an upper bound where the capacity is obtained based on the optimal phase shifts using the true channels G and h;
Perfect channel and perfect covariance (PC-PCov): the capacity is computed based on the true RIS-BS channel G and the true UE-RIS CCM Rₕ;
Random phase-shifts: this represents a lower bound for our method.
MO-EST: This method is based on alternating minimization and manifold optimization [46].

### B. Model Details and Hyperparameters Settings

Following a hyperparameters tuning process, the performance of the VI-based neural networks has been significantly enhanced. The hyperparameters tuning was conducted using the Bayesian method [47] which includes optimization in the search for the optimal hyperparameters. The hyperparameters tuned consist of the architecture of the neural networks, the use of dropout layers and the learning rate. The architecture adopted for the JCE method features fully connected neural networks for both Encoder [symbol] and Encoder [symbol] . They consist of an input layer, two 300-unit hidden layers with Relu activation combined with a dropout layer and a batch normalization layer, and an output layer with two heads: the first outputs the mean after a Tanh activation and the second uses Softmax activation for scale. Conversely, for the JCCE method, the architecture of the encoders is maintained, and the output layer of Encoder [symbol] that models the auxiliary distribution q_{λ}_{₁}(d|\tilde{Y}) is adapted to have one head with a Sigmoid activation. Adam optimizer [48] is used to train the neural networks with 0.1 as an initial learning rate. The neural networks are trained by minimizing the ELBO functions using 10⁴ unlabeled samples. The priors' statistical parameters are chosen as α_{G}_{^{vir}}=αₕ_{^{vir}}=α_{d}=1. The expectations within the ELBO functions are evaluated using Monte-Carlo with 1000 samples. The methods are tested based on 50 Monte-Carlo samples.

### C. Channel Model

A mmWave channel model is adopted, as follows [46]:

$$G = \sqrt{\frac{M N}{P}} {\sum }_{p = 1}^{P} {α}_{p} {a}_{B S} ( {θ}_{p} ) {a}_{RIS}^{H} ( {ϕ}_{p} , {φ}_{p} ) , \qquad ( 43 )$$

$$h = \sqrt{\frac{N}{Q}} {\sum }_{q = 1}^{Q} {β}_{q} {a}_{RIS} ( {ϕ}_{q} , {φ}_{q} ) , \qquad ( 44 )$$

where αₚ, θₚ, and ϕₚ/φₚ denote the complex gain, AoA, and azimuth/elevation of angle of departure (AoD) of the p-th path of RIS-BS channel. Similarly, β_{q} and ϕ_{q}/φ_{q} denote the complex gain and azimuth/elevation AoA of the q-th path of the UE-RIS channel, respectively. Besides, a_{BS} and a_{RIS} denote the receive and transmit array response vectors at the BS and the RIS, respectively. Then, the array response vector of the half-wavelength spaced uniform linear array at the BS is given by:

$${a}_{B S} ( {θ}_{p} ) = {\frac{1}{\sqrt{M}} [ 1 , {e}^{jπco s {θ}_{p}} , … , {e}^{j π ( M - 1 ) co s {θ}_{p}} ]}^{T} . \qquad ( 45 )$$

In addition, the array response vector of the planar array at the RIS involving N elements is given by:

$${a}_{RIS} ( ϕ , φ ) = \frac{1}{\sqrt{N}} [ \begin{matrix}1 \\ {e}^{j π s i n ϕs i n φ} \\ ⋮ \\ {e}^{j π \sqrt{N} s i n ϕs i n φ}\end{matrix} ] ⊗ [ \begin{matrix}1 \\ {e}^{j π co s φ} \\ ⋮ \\ {e}^{j π \sqrt{N} co s φ}\end{matrix} ] . \qquad ( 46 )$$

Two channel generation modes are used to train and test the novel methods:
Mode 1: The AoAs ϕ_{q} and φ_{q} are uniformly generated from the interval [0,2π), and this mode is used to evaluate the JCE method.
Mode 2: It adopts a different approach by generating AoAs Oq and pq from different clusters, dividing the interval [0,2π) into 100 sub-intervals. This clustering results in a covariance matrix that exhibits sparsity in the angular domain. This mode is used to evaluate the JCCE approach.

### D. Performance of Joint Channel Estimation

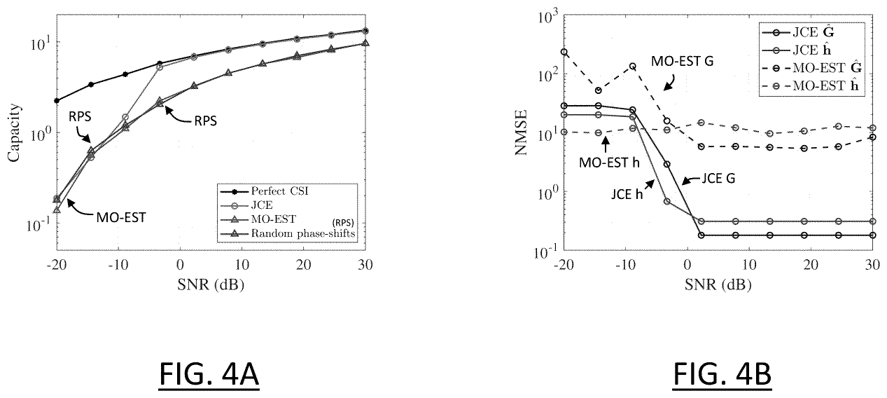

The performance of the proposed JCE method was evaluated using mmWave channels generated according to Mode 1. To estimate the UE-RIS and the RIS-BS channels, Nₚ=50 pilot symbols are sent over an uplink SIMO RIS-assisted mmWave communication system with number of paths Q=1 and P=3 for the UE-RIS and RIS-BS channels, respectively, and the training signals which are fed to the trained neural networks Encoder [symbol] and Encoder [symbol] are obtained. FIG. 4A illustrates the capacity as a function of the SNR ρ. The phase-shifts derived from the estimated channels are able to achieve a better capacity than the random selection of the RIS configuration which validates that the neural networks are able to effectively learn the channels. Moreover, the novel method outperforms the MO-EST method primarily due to the ability of neural networks to capture the sparse structure of the channels at high dimensions. In particular, the JCE method demonstrates a notable improvement with a gain of 3.70 dB at −3.33 dB SNR compared to the MO-EST method and achieves a gain of 1.35 dB at 30 dB SNR.

Next, the estimation error of both channels UE-RIS and RIS-BS was investigated. As depicted in FIG. 4B, the NMSE decreases with increasing SNR. Notably, the learning-based approach of the novel method significantly outperforms the MO-EST baseline. In addition, the novel method presents a lower computation time than the iterative algorithm MO-EST by leveraging the significantly lower inference time of the neural networks. Specifically, at 20 dB of SNR, the neural networks predict the auxiliary parameters within 0.20 seconds, whereas MO-EST requires 1.45 seconds to estimate the channels.

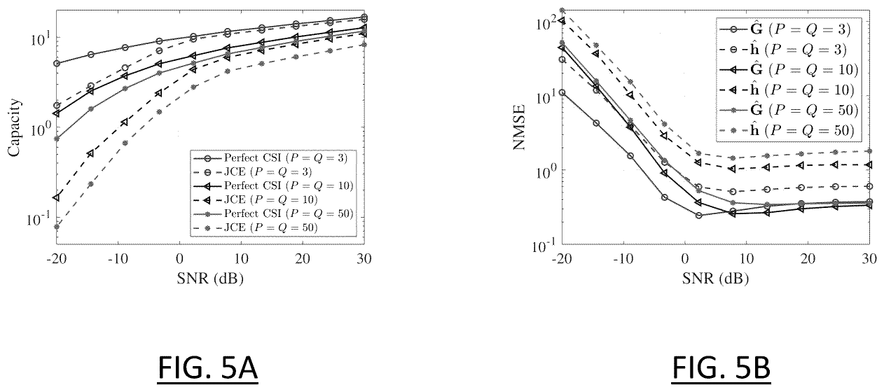

Furthermore, the JCE method was evaluated under different number of paths investigating the effect of the level of sparsity on the estimation performance. FIG. 5A presents the capacity as a function of the SNR for three scenarios: P=Q=3, P=Q=10, and P=Q=50. The numerical results reveal that, under high SNR, the capacity achieved based on phase-shifts derived from the estimated channels converges towards the exact capacity obtained when employing phase-shifts derived from the perfect CSI. Furthermore, a notable impact of channel sparsity is observed on the estimation performance in terms of capacity. Specifically, as the channel sparsity increases, signifying a reduced number of propagation paths, the achieved capacity becomes increasingly closer to the exact capacity due to the improvement of estimation of the channels. This behavior can be attributed to the sparsity-inducing nature of the variational loss function employed by the encoders, which leverages a Laplace prior to enforcing a sparse structure over the channels. Consequently, the novel JCE method demonstrates superior performance for scenarios involving more sparse channels compared to those with less sparsity. FIG. 5B depicts the evaluation of the NMSE to assess the performance of the proposed method. Notably, as the SNR increases, a clear trend emerges where the NMSE consistently decreases. Additionally, the degree of sparsity in the channel in the angular domain h^{vir} plays a critical role [49]. More specifically, the NMSE exhibits a significant degradation when the number of paths increases, with the most substantial performance deterioration occurring when P=Q=50 paths are considered. This degradation can be attributed to the fact that 50 paths approach the dimensionality of the channel vector h∈ [symbol] ⁶⁴. Conversely, for the RIS-BS channel G^{vir}, the NMSE experiences a minor degradation as the number of paths varies. This behavior stems from the larger dimensionality of the RIS-BS channel matrix, M×N=256, in relation to the maximum number of paths, mitigating the impact of variations in the number of paths. These findings highlight the superior efficiency of the novel method in scenarios characterized by higher levels of sparsity, effectively bypassing a priori knowledge of the specific number of paths.

### E. Comparison Between the Proposed Methods

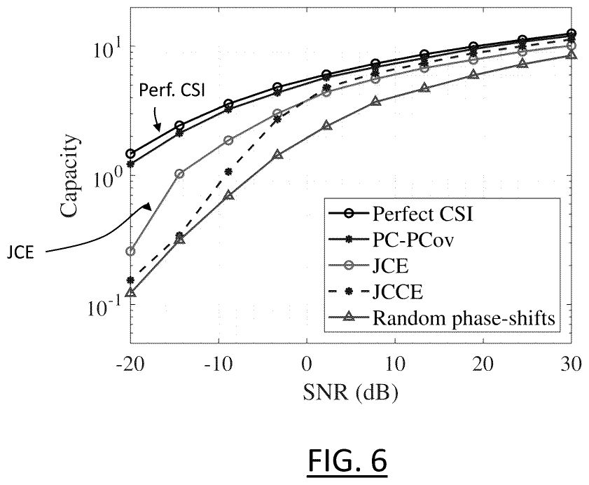

To compare the JCE and JCCE methods, the capacity was evaluated taking into account the number of pilots used to get the training signals that is expressed as Cₚ=(1−α)log₂(1+ρ∥G diag(v)h∥²) where α=N_{pilots used}/N_{Total transmissions}. The parameters Nₚ=4 and N_{b}=200 were considered to obtain the training signal with channels generated in Mode 2. At coherence times T_{G} and Tₕ in the order of 100 ms and 0.1 ms, respectively, FIG. 6 shows that the JCE method exhibits superior performance over the JCCE approach at low SNR, while the JCCE method outperforms the JCE at high SNR when the estimates closely approach the PC-PCov. The observed performance improvement can be attributed to the inherent differences in their channel estimation approaches. With the JCE, the channels G and h are estimated at each coherence block of h, which is relatively short compared to the quasi-static nature of channel G and the covariance Rₕ, and thus it leads to higher values of α, i.e., higher training overhead. In contrast, the JCCE method utilizes the estimates of the RIS-BS channel and the UE-RIS CCM, enabling the use of phase-shifts without estimating the UE-RIS in subsequent coherence blocks. This leads to reduced training overhead, resulting in lower values of a, which validates the efficiency of leveraging the estimates of the RIS-BS channel and the UE-RIS CCM for obtaining the phase-shifts. Furthermore, an additional overhead of signaling complexity is incurred to update the phase-shifts while using the I-CSI estimates that degrades the effective achievable rate. This makes optimizing the phase-shifts based on I-CSI estimates less appealing in practical scenarios.

### F. Performance of Joint Channel-Covariance Estimation

The following parameter values were selected for simulations: Nₚ=4 for the number of pilot symbols per UE-RIS coherence block and N_{b}=200 for the number of coherence blocks for UE-RIS channel. To evaluate the JCCE method, it was compared against the MO-EST estimation approach, where the channels are estimated at each coherence block and used to estimate the covariance matrix Rₕ. P=3 and Q=1 to represent the number of paths for the RIS-BS and UE-RIS channels, respectively.

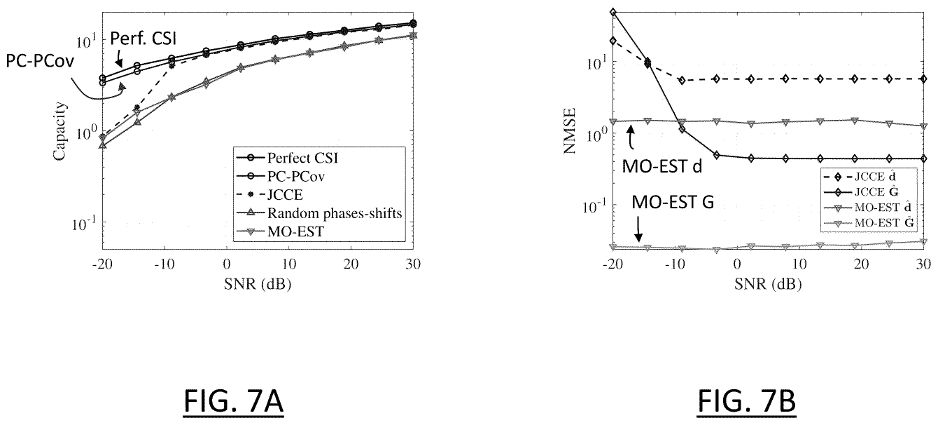

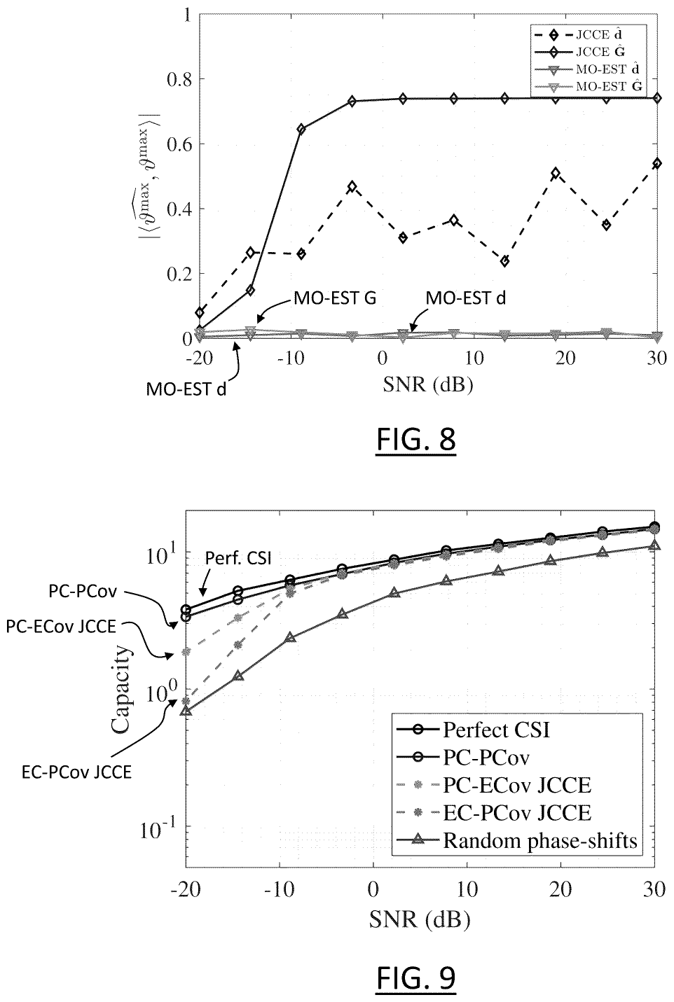

FIG. 7A shows a degradation in performance by substituting the UE-RIS covariance matrix (PC-PCov) for the UE-RIS channel itself (Perfect CSI). However, by updating the RIS phase-shifts based on the UE-RIS CCM, the signaling overhead associated with the RIS configuration is reduced. This approach enables the RIS configuration to remain fixed for an extended period while ensuring an acceptable rate performance since the UE-RIS CCM and the RIS-BS channel are considered quasi-static for the subsequent coherence blocks of the UE-RIS channel. Moreover, the capacity values using the phase-shifts derived from the estimated channel and the CCM via JCCE get closer with the increase of the SNR to the exact capacity which validates the proposed method. Furthermore, the novel method demonstrates superior performance compared to the MO-EST method which fails to capture the sparse structure of the channel and its covariance. FIG. 7B showcases the NMSE evaluation across different SNR values. Notably, the MO-EST method reaches lower values of NMSE compared to the proposed method for the RIS-BS channel G and the angular spectrum d. For further investigation, in FIG. 8, the absolute value of the complex inner product of the largest eigenvectors of the estimated RIS-BS channels Ĝ and the estimated CCM \hat{R}ₕ, expressed as [symbol] , ϑ^{max} [symbol] = [symbol] ϑ^{max}, with the largest eigenvectors from the PC-PCov, was evaluated. Based on this, the novel method is able to effectively estimate the largest eigenvectors of the RIS-BS channel and the UE-RIS covariance matrix, as the inner product gets closer to 1, with the increase of the SNR. This can be interpreted as an alignment of the estimated largest eigenvector to the largest eigenvector of the actual channel and covariance matrix.

### G. Effectiveness of Separate Channel Estimates

The performance of each estimate was examined, aside from the baselines of the capacity with phase-shifts derived from the exact channels and the phase-shifts derived from the exact RIS-BS channel and UE-RIS CCM. FIG. 9 shows the effectiveness of both neural networks Encoder [symbol] and Encoder [symbol] to estimate approximate posterior distributions to achieve desirable performance. At high SNR, both estimates, which are referred to as Perfect Channel Estimated Covariance (PC-ECov) and Estimated Channel Perfect Covariance (EC-PCov), can separately achieve the capacity with perfect RIS-BS channel and UE-RIS CCM. However, at low SNR, the covariance matrix estimates surpass the capacity achieved using channel estimates. This superiority is attributed to the highly sparse structure present in d, originating from the clusters of AoAs and AoDs contributing to the UE-RIS channel h. Moreover, the vector d has a lower dimension of d∈ [symbol] ^{N} compared to the RIS-BS channel G∈ [symbol] ^{M×N}, which facilitates the estimation of the non-sparse values.

### H. Impact of Number of Coherence Blocks

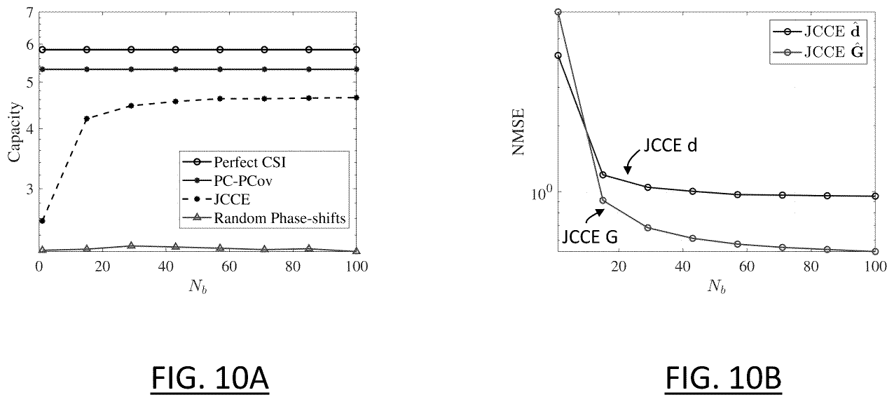

JCCE methods' performance was assessed in terms of the number of coherence blocks at SNR=5 db. FIG. 10 depicts capacity and NMSE for different N_{b} values. Increasing the number of coherence blocks is equivalent to increasing the number of realizations of the UE-RIS channel encompassed in the training signals from which the RIS-BS channel and the UE-RIS CCM are estimated. As shown in FIG. 10A, the JCCE does not consider a large number of UE-RIS realizations to accurately estimate the covariance matrix which is of size N×N. This efficiency is attributed to the VI framework embraced by JCCE, leveraging the low-rank structure of the UE-RIS CCM. Therefore, the JCCE significantly reduces the required number of UE-RIS channel realizations for estimating the covariance matrix compared to the maximum likelihood estimator which involves a number of estimates larger than N. Furthermore, the NMSE of the RIS-BS channel consistently decreases with an increasing number of coherence blocks. This improvement is attributed to the increase of training signal obtained during the N_{b} coherence blocks, thereby resulting in a more precise estimation. Correspondingly, the NMSE of the vector d has a similar performance, depicting a reduction in error as the number of coherence blocks augments. This simulation assesses the effectiveness of the JCCE method and motivates the consideration of the UE-RIS CCM sparsity during estimation to reduce the training overhead.

### I. Complexity Analysis

With respect to time-complexity analysis, the neural networks are trained in offline mode, and therefore are evaluated only is the inference mode, i.e., the forward propagation. The conventional method to evaluate the time-complexity of a neural network is the floating-point operations per second (FLOPs) [50]. For any fully connected layer Lᵢ of input size Iᵢ and output size Oᵢ that follows a dropout of rate 1−r and a batch normalization layers, the number of FLOPs is given by

$$FLOPs ( {L}_{i} ) = 4 rI + 2 {rI}_{i} {O}_{i} . \qquad ( 47 )$$

Thus, the total number of FLOPs of the proposed neural network with 2 hidden layers yields

$$FLOPs = 4 rl + {\underbrace{2}}_{input \to {L}_{1}} {r IH}_{1} + 4 {r H}_{1} + {{2}_{︶}}_{{L}_{1} \to {L}_{2}} {rH}_{1} {H}_{2} + 4 {H}_{2} + {{2}_{︶}}_{{L}_{2} \to output} {H}_{2} O \qquad ( 48 )$$

$$= I \cdot ( 4 r + 2 {r H}_{1} ) + O \cdot 2 {H}_{2} + ( 2 {rH}_{1} + 2 {rH}_{1} {H}_{2} + 4 {H}_{2} ) ,$$

where H₁ and H₂ denote the size of the two hidden layers L₁ and L₂, respectively, r is the dropout rate applied before the two hidden layers, I represents the size of the input, and O the size of the output. Table 3 compares the order of complexity of inference of the proposed VI-based methods. Note that the input of the encoders are complex numbers, so the size of the input is multiplied by two considering the real and imaginary parts. That is, for the JCE method, the input to the neural networks is of size 2MNₚ. Moreover, a preprocessing is performed to the training signal for the JCCE method, i.e., \tilde{Y}\tilde{Y}^{H}/N_{b}−I_{MN}_{ₚ}, that adds a number of FLOPs equal to 4MNₚN(MNₚ+1)+2MNₚ.

### VII. CONCLUSION

Channel estimation poses a notable challenge for fully passive RIS-aided systems and the effectiveness of estimation schemes is dependent on the specific scenarios in which RIS systems are deployed. This disclosure relates to the CSI estimation problem in RIS-aided mmWave communication systems with fully-passive RIS elements using a VI-based framework to approximate the intractable posterior distribution of the channels with auxiliary distributions. In particular, there are two different novel approaches addressing two scenarios in which the RIS is deployed. The first method, named JCE, separately estimates the UE-RIS and RIS-BS I-CSI that is suitable for scenarios with low mobile users. This method is useful for decoupling the cascaded channels and allows the identification of the channels' behavior in each part. However, its main limitation lies in its susceptibility to high training and signaling overhead as the UR-RIS channel becomes more dynamic for high mobile users. To overcome this challenge, leveraging the slow-varying nature of the RIS-BS I-CSI and the UE-RIS S-CSI, a second method is disclosed, namely JCCE, that extends the VI-based framework used for JCE to estimate the RIS-BS channel and the UE-RIS CCM. Lastly, closed-form expressions of the phase-shifts are given, based on the obtained estimates for each use case considered in the methods. Sampling from the optimized auxiliary posterior distributions yields a capacity that is close to the one achieved with perfect CSI. Moreover, the JCCE provides an improvement of spectral efficiency through the reduction of the training overhead by relying on the slow-varying S-CSI of the UE-RIS channel rather than the I-CSI for the passive beamforming. Further development on the invention may include a more physically consistent RIS modeling, where the elements of the RIS experience mutual coupling, which leads to a non-diagonal reflection matrix. In addition, the multi-user scenario can be appropriately managed by employing identical phase-shifts for nearby users who share a similar covariance matrix.

### Supplementary Material

A detailed derivation of the losses is provided, under the distributions investigated.

The entropy of a complex Laplace random variable z˜ [symbol] (m, b) with mean m and scale b is derived as:

$$H ( q ( z ) ) = {\int }_{ℂ} - q ( z ) log q ( z ) dz = {\int }_{c} - \frac{1}{2 π {b}^{2}} {e}^{- \frac{\vert z - m \vert}{b}} log \frac{1}{2 π {b}^{2}} {e}^{- \frac{\vert z - m \vert}{b}} {d}_{Z} = log ( 2 π {b}^{2} ) + {\int }_{ℂ} \frac{\vert u \vert}{2 π {b}^{3}} {e}^{- \frac{\vert u \vert}{b}} d u ( u = z - m ) = log ( 2 π {b}^{2} ) + 2 . \qquad ( 49 )$$

Next, the closed-form of [symbol] ₃^{I-CSI} (Eq. (13)) with complex Laplace priors is derived. In the first step, the expectation over h^{vir} is computed, where

$$A = \frac{\sqrt{ρ}}{M {N}^{2}} {F}_{M}^{H} {G}^{vir} {F}_{N}^{H} diag ( {v}_{l} ) {F}_{N}^{H} {x}_{l}$$

which is a constant with respect to h^{vir}:

$${ℒ}_{3}^{I - CSI} = {\sum }_{l = 1}^{{N}_{p}} {𝔼}_{{h}^{vir} , {G}^{vir} \sim {q}_{λ} ( {h}_{vir} , {G}_{vir} \vert Y )} [ {( {y}_{l} - A {h}^{vir} )}^{H} \times ( {y}_{l} - A {h}^{vir} ) ] + {C}_{1} = {\sum }_{l = 1}^{{N}_{p}} {𝔼}_{{G}^{vir} \sim {q}_{{λ}_{2}} ( {G}^{vir} \vert Y )} [ Tr ( A Λ {A}^{H} ) + {( {y}_{l} - Am )}^{H} ( {y}_{l} - Am ) ] + {C}_{1} , \qquad ( 50 )$$

where C₁ is a constant, m a vector of means of h^{vir} following q_{λ}_{₁}(h^{vir}|Y) distribution and

$$Λ = {𝔼}_{{h}^{vir} \sim {q}_{{λ}_{1}} ( {h}^{vir} \vert Y )} [ ( {h}^{vir} - m ) {( {h}^{vir} - m )}^{H} ]$$

is the covariance matrix of h^{vir}. The latter is a diagonal matrix with a main diagonal containing the variances of the elements. The variance of a complex Laplace is defined as follows:

$$Var ( z ) = {\int }_{ℂ} \frac{{\vert z - m \vert}^{2}}{2 π {b}^{2}} {e}^{- \frac{\vert z - m \vert}{b}} dz = {\int }_{ℂ} \frac{{\vert u \vert}^{2}}{2 π {b}^{2}} {e}^{- \frac{\vert u \vert}{b}} du ( Substitution u = z - m ) = {\int }_{0}^{2 π} {\int }_{0}^{∞} \frac{{r}^{2}}{2 π {b}^{2}} {e}^{- \frac{r}{{b}_{r}}} drd θ ( polar coordinates ) = 6 {b}^{2} . \qquad ( 51 )$$

Hence, the covariance matrix ∧ is expressed as follows:

∧_{i,j}=6 diag(b)² (52)

To compute G^{vir}, a constant matrix

$$C = \frac{\sqrt{ρ}}{M {N}^{2}} {F}_{N}^{H} diag ( {v}_{l} ) {F}_{N}^{H} {x}_{l} ,$$

i.e, A=F_{M}^{H}G^{vir}C is defined. Hence:

$${ℒ}_{3}^{I - CSI} = {\sum }_{l = 1}^{{N}_{p}} {𝔼}_{{G}^{vir} \sim q ( {G}^{vir} \vert Y )} [ Tr ( {A}^{H} A Λ ) + {( {y}_{l} - Am )}^{H} ( {y}_{l} - Am ) ] + {C}_{1} = {\sum }_{l = 1}^{{N}_{p}} {𝔼}_{{G}^{vir} \sim q ( {G}^{vir} \vert Y )} [ MTr ( {C}^{H} {G}^{{vir}^{H}} {G}^{vir} C Λ ) + {( {y}_{l} - {F}_{M}^{H} {G}^{vir} Cm )}^{H} ( {y}_{l} - {F}_{M}^{H} {G}^{vir} Cm ) ] + {C}_{1} . \qquad ( 53 )$$

Then, the property [symbol] _{G}_{^{vir}} [G^{vir}^{^{H}}G^{vir}]=Q+M^{H}M is used, where Q= [symbol] _{G}_{^{vir}} [(G^{vir}−M)^{H}(G^{vir}−M)] is the covariance matrix over the columns of G^{vir}. Q is a diagonal matrix since the elements G_{i,j}^{vir} are assumed to be independent which makes the columns are independent as well and the elements on the diagonal are given by:

$${Q}_{i , i} = {\sum }_{m = 1}^{M} Var ( {G}_{m , i}^{vir} ) = {\sum }_{m = 1}^{M} 6 {B}_{m , i}^{2} . \qquad ( 54 )$$

### Therefore:

$${ℒ}_{3}^{I - CSI} = {\sum }_{l = 1}^{{N}_{p}} [ MTr ( {C}^{H} QC Λ ) + MTr ( {C}^{H} {M}^{H} MC Λ ) + {( {y}_{l} - {F}_{M}^{H} MCm )}^{H} ( {y}_{l} - {F}_{M}^{H} MCm ) + {Mm}^{H} {C}^{H} QCm ] + {C}_{1} .$$

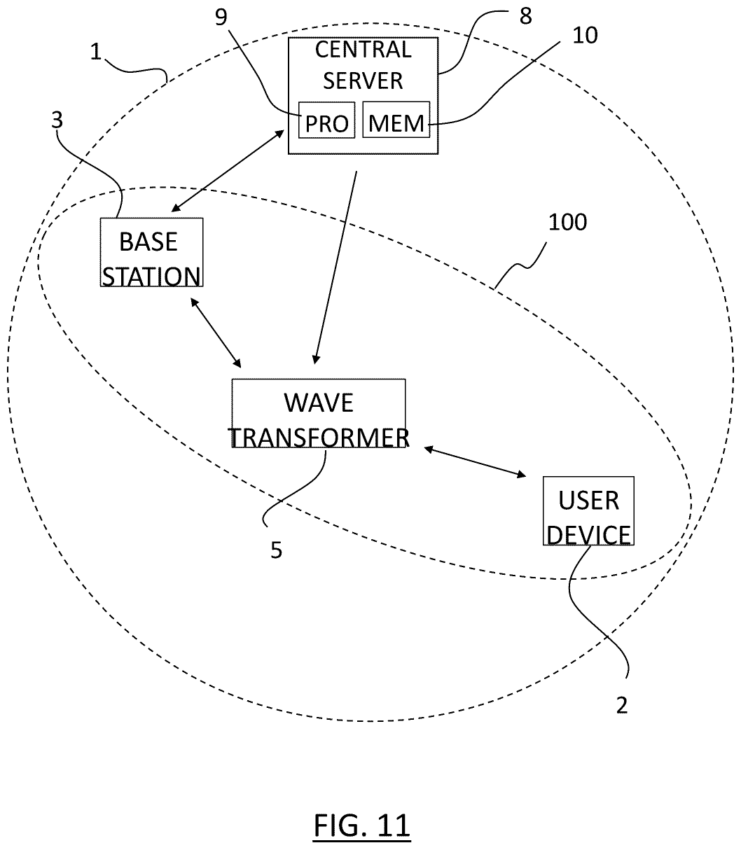

FIG. 11 shows a communication channel 100 in a wireless communication network 1 between a user device 2 and an access point 3. The access point 3, which may be alternatively referred to as a base station, has plural antennas and is configured to wirelessly communicate with the user device, which is a mobile communication device assigned to an end-user of the wireless communication network. Typically, the user device 2 has only one antenna. Generally speaking, the wireless communication network includes a plurality of the access points at geographically spaced locations from each other and a plurality of the user devices, also typically at geographically spaced locations from each other and from the access points. A communication channel is formed between each pair of one access point and one user device, typically those that are geographically closest to each other, that is closest in geographical distance. The access points are stationary meaning their locations within the communication network are fixed and the user devices are mobile meaning their geographical location may change with time within the communication network.

Further to the user device 2 and the access point 3, the wireless communication network includes a wave transformer 5 located at a geographically intermediate location between the access point 3 and the user device 2 and configured to reflect or redirect electromagnetic signals between the access point 3 and the user device 2. Typically, the wireless communication network includes a plurality of the wave transformers at geographically spaced locations from each other and from the access points. When there are a plurality of wave transformers, and a plurality of access points, then for a communication channel including a respective one of the user devices, the channel is formed between a respective one of the access points geographically closest to the user device and includes a respective one of the wave transformers which is geographically closest to an imaginary line interconnecting geographical locations of the respective access point and the respective user device between which the communication channel is formed.

The wave transformer 5 has a plurality of electronically reconfigurable antennas, so that it is a wave transformer of an artificial type, which is typically referred to in industry as a reconfigurable intelligent surface.

Yet further to the aforementioned elements of the network, the wireless communication network includes a central server 8 having a processor 9 and a non-transitory memory 10 operatively connected to the processor and storing instructions to be executed thereon. The central server 8 is communicatively connected to the access point 3, so as to be arranged to communicate or exchange data therebetween, and configured to control the wireless communication network. With respect to the wave transformer, however, the central server 8 is free of data connection with the wave transformer, such that data cannot be exchanged or communicated therebetween. The central server 8 may however be in control connection with the wave transformer, that is it may be communicatively connected to the wave transformer in such a manner as to transmit control or operational instructions, for example, regarding configuration of one or more of the antennas of the wave transformer.

The communication channel effectively has two constituent portions substantially defining a path of transmission of data between the access point and the user device. The constituent portions include a first portion between the access point and the wave transformer, which typically is static because both the access point and the wave transformer are stationary, and a second portion between the wave transformer and the user device, which is dynamic because the user device is movable and so a geographical location thereof may vary over time.

It will be appreciated that each tractable statistical distribution, which is based on a received signal (at a receiving one of the access point and the user device relative to a direction of data transmission) and not a transmitted signal (from a transmitting one of the access point and the user device relative to the direction of data transmission) is intended to model or represent a statistical distribution of the communication channel, that is the communication channel at the time or point of transmission of data. This is in part because an exact posterior statistical distribution of each constituent channel portion is intractable.

It will be appreciated that training of the neural networks, which is preferably unsupervised, may be performed or conducted using empirical data, that is data derived from actual measurements in the communication channel, or synthetic data.

It will be appreciated that ‘likelihood term’ may be alternatively referred to as ‘reconstruction error term.’

As described hereinbefore, the present disclosure relates to channel estimation in reconfigurable intelligent surfaces (RIS)-aided systems, which is used for optimal configuration of the RIS and various downstream tasks like user localization. In RIS-aided systems, channel estimation involves estimating two channels for the user-RIS (UE-RIS) and RIS-base station (RIS-BS) links. In the literature, two approaches are proposed: (i) cascaded channel estimation where the two channels are collapsed into a single one and estimated using training signals at the BS, and (ii) separate channel estimation that estimates each channel separately either in a passive or semi-passive RIS setting. In this disclosure, the separate channel estimation problem is investigated in a fully passive RIS-aided millimeter-wave (mmWave) single-user single-input multiple-output (SIMO) communication system. First, a variational-inference (VI) approach is adopted to jointly estimate the UE-RIS and RIS-BS instantaneous channel state information (I-CSI). Particularly, auxiliary posterior distributions of the I-CSI are learned through the maximization of the evidence lower bound. However, estimating the I-CSI for both links in every coherence block results in a high signaling overhead in scenarios with highly mobile users. Thus, our first approach is extended to go beyond the quasi-static assumption and leverage the slow-varying property of the RIS-BS channel. Our second method estimates the channel covariance matrix of the UE-RIS channel instead of the instantaneous channel. The simulation results demonstrate that maximum a posteriori channel estimation using the auxiliary posteriors approaches the capacity with perfect CSI. Leveraging the UE-RIS CCM enhances spectral efficiency by minimizing the pilot signaling to control the RIS, and exploiting its low-rank structure reduces training overhead compared to the maximum likelihood estimator.

The scope of the claims should not be limited by the preferred embodiments set forth in the examples but should be given the broadest interpretation consistent with the specification as a whole.

### REFERENCES

[1] F. Fredj, A. Feriani, A. Mezghani, and E. Hossain, “Variational inference-based channel estimation for reconfigurable intelligent surfaceaided wireless systems,” in ICC 2023—IEEE International Conference on Communications, 2023, pp. 3456-3461.
[2] W. Saad, M. Bennis, and M. Chen, “A vision of 6 g wireless systems: Applications, trends, technologies, and open research problems,” IEEE network, vol. 34, no. 3, pp. 134-142, 2019.
[3] B. Zheng, C. You, W. Mei, and R. Zhang, “A survey on channel estimation and practical passive beamforming design for intelligent reflecting surface aided wireless communications,” IEEE Communications Surveys & Tutorials, vol. 24, no. 2, pp. 1035-1071, 2022.
[4] S. Dang, O. Amin, B. Shihada, and M.-S. Alouini, “What should 6 g be?” Nature Electronics, vol. 3, no. 1, pp. 20-29, 2020.
[5] Q.-U.-A. Nadeem, A. Kammoun, A. Chaaban, M. Debbah, and M.-S. Alouini, “Intelligent reflecting surface assisted wireless communication: Modeling and channel estimation,” arXiv preprint arXiv:1906.02360, 2019.
[6] X. Shao, C. You, W. Ma, X. Chen, and R. Zhang, “Target sensing with intelligent reflecting surface: Architecture and performance,” IEEE Journal on Selected Areas in Communications, vol. 40, no. 7, pp. 2070-2084, 2022.
[7] X. Pei, H. Yin, L. Tan, L. Cao, Z. Li, K. Wang, K. Zhang, and E. Bjornson, “Ris-aided wireless communications: Prototyping, adaptive beamforming, and indoor/outdoor field trials,” IEEE Transactions on Communications, vol. 69, no. 12, pp. 8627-8640, 2021.
[8] Y. Liu, X. Liu, X. Mu, T. Hou, J. Xu, M. Di Renzo, and N. AI-Dhahir, “Reconfigurable intelligent surfaces: Principles and opportunities,” IEEE communications surveys & tutorials, vol. 23, no. 3, pp. 1546-1577, 2021.
[9] L. You, J. Xiong, D. W. K. Ng, C. Yuen, W. Wang, and X. Gao, “Energy efficiency and spectral efficiency tradeoff in ris-aided multiuser mimo uplink transmission,” IEEE Transactions on Signal Processing, vol. 69, pp. 1407-1421, 2020.
[10] P. Staat, H. Elders-Boll, M. Heinrichs, R. Kronberger, C. Zenger, and C. Paar, “Intelligent reflecting surface-assisted wireless key generation for low-entropy environments,” in 2021 IEEE 32nd Annual International Symposium on Personal, Indoor and Mobile Radio Communications (PIMRC). IEEE, 2021, pp. 745-751.
[11] M. Di Renzo, K. Ntontin, J. Song, F. H. Danufane, X. Qian, F. Lazarakis, J. De Rosny, D.-T. Phan-Huy, O. Simeone, R. Zhang et al., “Reconfigurable intelligent surfaces vs. relaying: Differences, similarities, and performance comparison,” IEEE Open Journal of the Communications Society, vol. 1, pp. 798-807, 2020.
[12] S. Nandan and M. A. Rahiman, “Intelligent reflecting surface (irs) assisted mmwave wireless communication systems: A survey,” Journal of Communications, vol. 17, no. 9, 2022.
[13] H. Guo, C. Madapatha, B. Makki, B. Dortschy, L. Bao, M. Astrom, and T. Svensson, “A comparison between network-controlled repeaters and reconfigurable intelligent surfaces,” arXiv preprint arXiv:2211.06974, 2022.
[14] Q. Wu and R. Zhang, “Intelligent reflecting surface enhanced wireless network via joint active and passive beamforming,” IEEE Transactions on Wireless Communications, vol. 18, no. 11, pp. 5394-5409, 2019.
[15] C. Huang, A. Zappone, G. C. Alexandropoulos, M. Debbah, and C. Yuen, “Reconfigurable intelligent surfaces for energy efficiency in wireless communication,” IEEE Transactions on Wireless Communications, vol. 18, no. 8, pp. 4157-4170, 2019.
[16] P. Wang, J. Fang, H. Duan, and H. Li, “Compressed channel estimation for intelligent reflecting surface-assisted millimeter wave systems,” IEEE signal processing letters, vol. 27, pp. 905-909, 2020.
[17] B. Zheng, C. You, and R. Zhang, “Intelligent reflecting surface assisted multi-user ofdma: Channel estimation and training design,” IEEE Transactions on Wireless Communications, vol. 19, no. 12, pp. 8315-8329, 2020.
[18] K. Ardah, S. Gherekhloo, A. L. de Almeida, and M. Haardt, “Trice: A channel estimation framework for ris-aided millimeter-wave mimo systems,” IEEE signal processing letters, vol. 28, pp. 513-517, 2021.
[19] C. Liu, X. Liu, D. W. K. Ng, and J. Yuan, “Deep residual learning for channel estimation in intelligent reflecting surface-assisted multiuser communications,” IEEE Transactions on Wireless Communications, vol. 21, no. 2, pp. 898-912, 2021.
[20] W. Shen, Z. Qin, and A. Nallanathan, “Deep learning for superresolution channel estimation in reconfigurable intelligent surface aided systems,” IEEE Transactions on Communications, vol. 71, no. 3, pp. 1491-1503, 2023.
[21] S. Liu, Z. Gao, J. Zhang, M. Di Renzo, and M.-S. Alouini, “Deep denoising neural network assisted compressive channel estimation for mmwave intelligent reflecting surfaces,” IEEE Transactions on Vehicular Technology, vol. 69, no. 8, pp. 9223-9228, 2020.
[22] S. Zhang, S. Zhang, F. Gao, J. Ma, and O. A. Dobre, “Deep learning optimized sparse antenna activation for reconfigurable intelligent surface assisted communication,” IEEE Transactions on Communications, vol. 69, no. 10, pp. 6691-6705, 2021.
[23] G. T. de Araujo, A. L. De Almeida, and R. Boyer, “Channel estimation for intelligent reflecting surface assisted mimo systems: A tensor modeling approach,” IEEE Journal of Selected Topics in Signal Processing, vol. 15, no. 3, pp. 789-802, 2021.
[24] X. Hu, R. Zhang, and C. Zhong, “Semi-passive elements assisted channel estimation for intelligent reflecting surface-aided communications,” IEEE Transactions on Wireless Communications, vol. 21, no. 2, pp. 1132-1142, 2021.
[25] I.-s. Kim, M. Bennis, J. Oh, J. Chung, and J. Choi, “Bayesian channel estimation for intelligent reflecting surface-aided mmwave massive mimo systems with semi-passive elements,” arXiv preprint arXiv:2206.06605, 2022.
[26] S. E. Zegrar, L. Afeef, and H. Arslan, “A general framework for ris-aided mmwave communication networks: Channel estimation and mobile user tracking,” arXiv preprint arXiv:2009.01180, 2020.
[27] S. Palmucci, A. Guerra, A. Abrardo, and D. Dardari, “Two-timescale joint precoding design and ris optimization for user tracking in nearfield mimo systems,” IEEE Transactions on Signal Processing, 2023.
[28] M. R. Akdeniz, Y. Liu, M. K. Samimi, S. Sun, S. Rangan, T. S. Rappaport, and E. Erkip, “Millimeter wave channel modeling and cellular capacity evaluation,” IEEE journal on selected areas in communications, vol. 32, no. 6, pp. 1164-1179, 2014.
[29] M. He, J. Xu, W. Xu, H. Shen, N. Wang, and C. Zhao, “Ris-assisted quasi-static broad coverage for wideband mmwave massive mimo systems,” IEEE Transactions on Wireless Communications, vol. 22, no. 4, pp. 2551-2565, 2022.
[30] J. Xu, C. Yuen, C. Huang, N. UI Hassan, G. C. Alexandropoulos, M. Di Renzo, and M. Debbah, “Reconfiguring wireless environments via intelligent surfaces for 6 g: reflection, modulation, and security,” Science China Information Sciences, vol. 66, no. 3, p. 130304, 2023.
[31] Y. Han, W. Tang, S. Jin, C.-K. Wen, and X. Ma, “Large intelligent surface-assisted wireless communication exploiting statistical csi,” IEEE Transactions on Vehicular Technology, vol. 68, no. 8, pp. 8238-8242, 2019.
[32] M.-M. Zhao, Q. Wu, M.-J. Zhao, and R. Zhang, “Intelligent reflecting surface enhanced wireless networks: Two-timescale beamforming optimization,” IEEE Transactions on Wireless Communications, vol. 20, no. 1, pp. 2-17, 2020.
[33] F. Yang, J.-B. Wang, H. Zhang, C. Chang, and J. Cheng, “Intelligent reflecting surface-assisted mmwave communication exploiting statistical csi,” in ICC 2020-2020 IEEE International Conference on Communications (ICC). IEEE, 2020, pp. 1-6.
[34] S. Park and R. W. Heath, “Spatial channel covariance estimation for mmwave hybrid mimo architecture,” in 2016 50th Asilomar Conference on Signals, Systems and Computers. IEEE, 2016, pp. 1424-1428.
[35] H. Wang, J. Fang, H. Duan, and H. Li, “Spatial channel covariance estimation and two-timescale beamforming for irs-assisted millimeter wave systems,” IEEE Transactions on Wireless Communications, 2023.
[36] X. Xia, K. Xu, S. Zhao, and Y. Wang, “Learning the time-varying massive mimo channels: Robust estimation and data-aided prediction,” IEEE Transactions on Vehicular Technology, vol. 69, no. 8, pp. 8080-8096, 2020.
[37] Z. Zhang, X. Cai, C. Li, C. Zhong, and H. Dai, “One-bit quantized massive mimo detection based on variational approximate message passing,” IEEE Transactions on Signal Processing, vol. 66, no. 9, pp. 2358-2373, 2017.
[38] X. Cheng, J. Sun, and S. Li, “Channel estimation for fdd multi-user massive mimo: A variational bayesian inference-based approach,” IEEE Transactions on Wireless Communications, vol. 16, no. 11, pp. 7590-7602, 2017.
[39] S. Haghighatshoar and G. Caire, “Massive mimo channel subspace estimation from low-dimensional projections,” IEEE Transactions on Signal Processing, vol. 65, no. 2, pp. 303-318, 2016.
[40] D. G. Tzikas, A. C. Likas, and N. P. Galatsanos, “The variational approximation for bayesian inference,” IEEE Signal Processing Magazine, vol. 25, no. 6, pp. 131-146, 2008.
[41] D. M. Blei, A. Kucukelbir, and J. D. McAuliffe, “Variational inference: A review for statisticians,” Journal of the American statistical Association, vol. 112, no. 518, pp. 859-877, 2017.
[42] C. Zhang, J. Butepage, H. Kjellstrom, and S. Mandt, “Advances in variational inference,” IEEE transactions on pattern analysis and machine intelligence, vol. 41, no. 8, pp. 2008-2026, 2018.
[43] Y. Miao, L. Yu, and P. Blunsom, “Neural variational inference for text processing,” in International conference on machine learning. PMLR, 2016, pp. 1727-1736.
[44] V. D. P. Souto, R. D. Souza, B. F. Uchoa-Filho, A. Li, and Y. Li, “Beamforming optimization for intelligent reflecting surfaces without CSI,” IEEE Wireless Communications Letters, vol. 9, no. 9, pp. 1476-1480, 2020.
[45] M. Figurnov, S. Mohamed, and A. Mnih, “Implicit reparameterization gradients,” Advances in neural information processing systems, vol. 31, 2018.
[46] T. Lin, X. Yu, Y. Zhu, and R. Schober, “Channel estimation for irsassisted millimeter-wave mimo systems: Sparsity-inspired approaches,” IEEE Transactions on Communications, vol. 70, no. 6, pp. 4078-4092, 2022.
[47] J. Wu, X.-Y. Chen, H. Zhang, L.-D. Xiong, H. Lei, and S.-H. Deng, “Hyperparameter optimization for machine learning models based on bayesian optimization,” Journal of Electronic Science and Technology, vol. 17, no. 1, pp. 26-40, 2019.
[48] D. P. Kingma and J. Ba, “Adam: A method for stochastic optimization,” arXiv preprint arXiv:1412.6980, 2014.
[49] J. Xu, W. Xu, D. W. K. Ng, and A. L. Swindlehurst, “Secure communication for spatially sparse millimeter-wave massive mimo channels via hybrid precoding,” IEEE Transactions on Communications, vol. 68, no. 2, pp. 887-901, 2019.
[50] F. Fredj, Y. AI-Eryani, S. Maghsudi, M. Akrout, and E. Hossain, “Distributed beamforming techniques for cell-free wireless networks using deep reinforcement learning,” IEEE Transactions on Cognitive Communications and Networking, vol. 8, no. 2, pp. 1186-1201, 2022.

### Tables

TABLE 1
Summary of channel estimation methods in RIS-aided systems

| | | | Type of |
|---|---|---|---|
| | | | estimated |
| Ref | Main contribution | Type of RIS | CSI |
| [16], [18] | Cascaded channel | Passive | Cascaded |
| | estimation based exploiting | | I-CSI |
| | low-rank structure of | | |
| | mmWave channels | | |
| [17] | Cascaded channel | Passive | Cascaded |
| | estimation for multi-user | | I-CSI |
| | setting in OFDMA system | | |
| [19], [20] | Cascaded channel | Passive | Cascaded |
| | estimation using hybrid | | I-CSI |
| | supervised DL techniques | | |
| | to denoise estimates | | |
| [21], [22] | Cascaded channel | Semi-passive | Cascaded |
| | estimation based on | | I-CSI |
| | supervised CNNs to | | |
| | improves estimates | | |
| [23] | Separate channel | Passive | Cascaded |
| | estimation based on | | I-CSI |
| | factorization/decomposition | | |
| | of the cascaded channel | | |
| [24] | Separate channel | Semi-passive | Separate |
| | estimation based on signal | | I-CSI |
| | parameters via rotation | | |
| | invariance technique | | |
| | (ESPRIT) and multiple | | |
| | signal classification | | |
| | (MUSIC) | | |
| [25] | Separate channel | Semi-passive | Separate |
| | estimation using VI-sparse | | I-CSI |
| | bayesian learning relying | | |
| | on uplink training signal | | |
| [35] | Cascaded channel | Passive | Cascaded |
| | covariance estimation | | I-CSI |
| | based exploiting low-rank | | |
| | and 3-level Toeplitz | | |
| | structure of the covariance | | |
| | matrix | | |
| The | Amortized VI to separately | Passive | (i) Separate |
| instant | estimate in mmWave | | I-CSI; |
| disclosure | communication: (i) I-CSI of | | (ii) Hybrid: |
| | UE-RIS and RIS-BS | | I-CSI and |
| | channels, (ii) I-CSI of RIS- | | S-CSI |
| | BS channel and S-CSI of | | |
| | UE-RIS channel | | |

TABLE 2
List of symbols
System model

| | |
|---|---|
| ρ | Signal-to-noise ratio (SNR) |
| M, N | Number of BS antennas and RIS elements |
| Nₚ | Number of pilots per UE-RIS coherence block |
| N_{b} | Number of coherence blocks used for training |
| Q, P | Number of paths of UE-RIS and RIS-BS channels |
| v | The phase-shifts vector |
| h, G | UE-RIS and RIS-BS channels in the time domain |
| h^{vir}, G^{vir} | UE-RIS and RIS-BS channels in the angular domain |
| Rₕ, d | The covariance matrix and angular correlation vector |
| | of the UE-RIS link |
| Φ | RIS configuration used for uplink training |
| F_{N}, F_{M} | Discrete Fourier Transform matrices (DFT) |

Variational Inference

| | |
|---|---|
| [symbol] ^{I-CSI}, [symbol] ^{S-CSI} | ELBO functions |
| p(h, G\|Y) | True posterior |
| qλ₁ (h^{vir}\|Y) | Auxiliary posterior of UE-RIS channel in the angular |
| | domain |
| qλ₂ (G^{vir}\|Y) | Auxiliary posterior of RIS-BS channel in the angular |
| | domain |
| qλ₁ (d\|Y) | Auxiliary posterior of the angular correlation vector |
| p(h^{vir}) | Prior of the UE-RIS channel in the angular domain |
| p(G^{vir}) | Prior of the UE-RIS channel in the angular domain |
| p(d) | Prior of the angular correlation |
| [symbol] | Encoder predicts the statistical parameters λ₁ |
| [symbol] ₁ | Weights of Encoder [symbol] |
| [symbol] | Encoder predicts the statistical parameters λ₂ |
| [symbol] | Weights of Encoder [symbol] |

TABLE 3
Complexity analysis

| Model | FLOPs Encoder F | FLOPs Encoder G |
|---|---|---|
| JCE | 1087MNₚ + 3600N + 163740 | 1087MNₚ + 3600MN + 163740 |
| JCCE | 4MNₚN(MNₚ + 1) + 2MNₚ + | 4MNₚN(MNₚ + 1) + 2MNₚ + |
| | 1087(MNₚ)² + 600N + 163740 | 1087(MNₚ)² + 3600MN + 163740 |

1. A method of obtaining, within a wireless communication network, channel state information of a communication channel between a user device and an access point having plural antennas and configured to wirelessly communicate with the user device; wherein the wireless communication network further includes a wave transformer located at a geographically intermediate location between the access point and the user device and configured to reflect electromagnetic signals between the access point and the user device, wherein the wave transformer has a plurality of electronically reconfigurable antennas; wherein the wireless communication network includes a central server having a processor and a non-transitory memory operatively connected to the processor and storing instructions to be executed thereon, wherein the central server is communicatively connected to the access point and configured to control the wireless communication network, wherein the central server is free of data connection with the wave transformer; the method comprising:
forming a statistical model of the communication channel, wherein the statistical model of the communication channel comprises separate statistical models representative of constituent portions of the communication channel, wherein the constituent portions of the communication include a first portion between the access point and the wave transformer and a second portion between the wave transformer and the user device;
wherein forming the statistical model of the communication channel comprises:
receiving, at one of the access point and the user device, a signal transmitted from another one of the access point and the user device;
using respective machine learning algorithms configured to determine parameters of a type of tractable statistical distribution selected to represent both the first and second portions of the communication channel, processing the signal to determine the parameters of a first tractable statistical distribution of the selected type and representative of the first portion of the communication channel and the parameters of a second tractable statistical distribution of the selected type and representative of the second portion of the communication channel, so as to form parametrized first and second tractable statistical distributions respectively defining the separate statistical models of the first and second portions of the communication channel;
wherein, to determine parameters of a type of tractable statistical distribution selected to represent both the first and second portions of the communication channel, the respective machine learning algorithms are configured to solve an optimization problem to minimize an objective function thereof based on a lower bound of a log-likelihood function of the received signal and including (i) a first divergence term representative of a statistical distance between a prior statistical distribution representative of the first portion of the communication channel and the separate statistical model of the first portion of the communication channel, (ii) a second divergence term representative of a statistical distance between a prior statistical distribution representative of the second portion of the communication channel and the separate statistical model of the second portion of the communication channel and (iii) a likelihood term based on a difference between the received signal and a reconstructed signal formed by the separate statistical models of the first and second portions of the communication channel; and
after forming the statistical model of the communication channel, determining, using the statistical model, the channel state information of the communication channel.

2. The method of claim 1 wherein receiving, at one of the access point and the user device, a signal transmitted from another one of the access point and the user device comprises receiving, at the access point, a signal transmitted from the user device.

3. The method of claim 1 wherein the respective machine learning algorithms comprise neural networks.

4. The method of claim 1 wherein the first and second divergence terms are both of a Kullback-Leibler type.

5. The method of claim 1 wherein the type of tractable statistical distribution selected to represent both the first and second portions of the communication channel is one of Gaussian and Laplace.
